(19) United States
(12) Patent Application Publication
(10) Pub. No.: US 2025/0190734 A1
(43) Pub. Date: Jun. 12, 2025

(54) PRINT ACTIVATABLE ENVIRONMENTAL SENSOR PROVIDING A DELAYED THRESHOLD TEMPERATURE RESPONSE

(71) Applicant: Temptime Corporation, Morris Plains, NJ (US)

(72) Inventors: Brian S. HUFFMAN, Belle Mead, NJ (US); Deniz BOYU, Dover, NJ (US); Mohannad ABDO, Clifton, NJ (US)

(73) Assignee: Temptime Corporation, Morris Plains, NJ (US)

(21) Appl. No.: 18/535,733

(22) Filed: Dec. 11, 2023

(51) Int. Cl. G06K 19/06; G01K 3/04; G01K 11/12; G06K 19/08

(52) U.S. Cl. CPC G06K 19/06037; G01K 3/04; G01K 11/12; G06K 19/06084; G06K 19/086

(57) ABSTRACT

Printer activatable environmental exposure indicators utilizing chemical encapsulation are disclosed herein. An example activatable environmental exposure indicator includes a substrate, an environmental indicator material configured to respond to a predetermined environmental stimulus, a plurality of microcapsules on or embedded in the substrate, and a bar code layer containing a bar code symbol and a viewing area. The microcapsules contain the environmental indicator material and are configured to respond to at least one of an activation temperature and an activation pressure by allowing the environmental indicator material to be released from the microcapsules. The environmental indicator material, after being released from the microcapsules, is configured to respond to exposure to the predetermined environmental stimulus by causing a detectable response.

### BACKGROUND

Perishable products including pharmaceuticals, food products, biologics, which may become unfit or unsafe for use after a certain length of time, or after exposure to various environmental conditions such as high temperature, radiation, UV or light exposure, oxygen exposure, freezing, thawing, or simply the passage of time, or the combination of multiple conditions, such as cumulative excess heat exposure over time. It is desirable to include environmental exposure indicators on such perishable products, or on or in their containers or packaging, in order to detect when products are either unfit for use, or approaching the end of their useful life.

Particularly for sensitive indicators, or indicator materials intended to have a long shelf life, it is desirable that the indicators remain inactive until they are incorporated in a printed label, and/or actually paired with a product that is entering the supply chain or moving into a different phase of the supply chain. Having an indicator which is inactive until activation at a desired time may avoid the need to carefully control the environment in which the indicator is stored prior to activation. In a conventional indicator that does not have an activation, the indicator may need to be stored in highly controlled conditions prior to deployment with a product, possibly from the moment it is created. For example, a cumulative heat indicator might need to be stored in a deep freeze prior to being paired with a product; a threshold indicator configured to detect heating above refrigeration temperatures would need to consistently be stored in a refrigerated environment prior to deployment; a sensitive humidity detector would need to be stored in controlled dry conditions. Accordingly, indicators which require an express action to “activate” the indicator and cause them to begin to operate are desirable for many applications. Prior “activatable” environmental indicators have included, for example, indicators with two chemical components, whose reaction controls the indicator process, which are provided separately and then are brought into contact using a physical connection. One example is the Safe-T-Vue® indicator from Zebra Technologies which include an indicator material in a separate reservoirs in a clamshell structure that is folded together to activate the device. A similar structure could be used to separate a two reactants in an indicator relying on a controlled reaction to produce a color change, where the activation brings the reactants into potential contact with other, and to react after a predetermined environmental exposure occurs. Another example is providing reactants in two films that are affixed to each other, e.g., with an adhesive, when the indicator is activated, such as the indicators described in U.S. Pat. No. 6,544,925 to Temptime Corporation, a Zebra Technologies company. Other examples include indicators with a removable film barrier that can be withdrawn, e.g., by manually pulling it out, from between the two chemical components, allowing them to come into contact and potentially to react with each other.

Bar codes are used in many applications, including logistics and product tracking. Two-dimensional bar codes have wide acceptance in such application, because they can contain a large amount of information in a small amount of area. The bar code symbols contain information regarding the product to which it is affixed such as product descriptions, manufacturer's information, dates created, expiration dates, weight, or price. Environmental exposure indicators have been combined with both one- and two-dimensional bar codes as part of the label manufacturing process, for example, by printing indicators on a label with a bar code symbol, or by printing a bar code symbols on label stock which has environmental indicators preprinted upon it.

Thermal printers, which use high temperature print heads to change the color of special printable media, are ubiquitous in the supply chains of many industries. The present disclosure describes activatable indicators that are may be optimized for use in the existing thermal printing ecosystem.

### SUMMARY

Disclosed herein are activatable environmental exposure indicators for providing an indication of the historical exposure of the activatable environmental indicator material to a predetermined environmental stimulus after an activation event.

In an embodiment, the present disclosure includes a method of monitoring exposure to time-temperature including receiving a time-temperature exposure label stock having an indicator material encapsulated in microcapsules in a reservoir on or in the label stock, the indicator material configured to liquefy in response to exceeding a predetermined temperature threshold, and wherein, while the microcapsules are intact, when the indicator material liquefies the microcapsules retain the indicator material in the reservoir; producing an activated label, e.g., by printing a bar code symbol on the label stock with a bar code printer, and releasing the indicator material from the microcapsules with the bar code printer allowing the indicator material to, responsive to the indicator material liquefying, move along a transport structure to a viewing area on the label stock causing a change in a color state of the viewing area, the movement requiring a predetermined amount of time when the indicator material remains at the predetermined temperature threshold; associating the activated label with a host product; reading the bar code symbol on the activated label with a bar code reader; and responsive to reading the bar code symbol, determining whether the host product is acceptable for use based at least in part on a color state of the viewing area.

In another aspect of the present disclosure, which may be used in combination with any other aspect or combination of aspects listed herein, the method further includes interpreting the color state of the viewing area based, at least in part on information read from the bar code symbol.

In another aspect of the present disclosure, which may be used in combination with any other aspect or combination of aspects listed herein, the viewing area is located in the bar code symbol, and information read from the bar code symbol by the bar code reader varies based on the color state of the viewing area.

In another aspect of the present disclosure, which may be used in combination with any other aspect or combination of aspects listed herein, a presence of the indicator material in the transport structure or the reservoir does not affect the information read from the bar code symbol.

In another aspect of the present disclosure, which may be used in combination with any other aspect or combination of aspects listed herein, the indicator material includes a meltable solid mixed with a colorant, and wherein the colorant is transported to the viewing area when the material moves along the transport structure to the viewing area, the colorant changing the color state of the viewing area when it reaches the viewing area.

In another aspect of the present disclosure, which may be used in combination with any other aspect or combination of aspects listed herein, the transport structure is a microchannel or a wick in fluid communication with the reservoir and viewing area.

In another aspect of the present disclosure, which may be used in combination with any other aspect or combination of aspects listed herein, the bar code symbol may have a symbology such as Aztec Code, Code 1, CrontoSign, CyberCode, DataGlyphs, Datastrip code, Data Matrix, GS1 Data Matrix, EZcode, High Capacity Color Barcode, InterCode, MaxiCode, MMCC, NexCode, PDF417, QR Code, GS1 QR Code, ShotCode, SPARQCode, Dot Code, and GS1 DotCode symbologies.

In another aspect of the present disclosure, which may be used in combination with any other aspect or combination of aspects listed herein, the temperature threshold is in the range of 5 C-65 C, 6 C-15 C, 8 C-12 C, or 9 C-11 C.

In another aspect of the present disclosure, which may be used in combination with any other aspect or combination of aspects listed herein, the predetermined amount of time is in the range of 45 minutes to 6 months, 2 to 4 hours, or 4 to 8 hours.

In another aspect of the present disclosure, which may be used in combination with any other aspect or combination of aspects listed herein, the indicator material is released by rupturing the microcapsules with a force applied by the bar code printer.

In another aspect of the present disclosure, which may be used in combination with any other aspect or combination of aspects listed herein, heat from the bar code printer weakens the microcapsules before the microcapsules are ruptured.

In another aspect of the present disclosure, which may be used in combination with any other aspect or combination of aspects listed herein, the microcapsules are melted by the bar code printer.

In another aspect of the present disclosure, which may be used in combination with any other aspect or combination of aspects listed herein, the indicator material may include a polymer having side-chain crystallinity, an alkane wax, a gel, a protein, a polyurea formaldehyde, a polymelamine formaldehyde, a wax material, or an emulsion.

In another aspect of the present disclosure, which may be used in combination with any other aspect or combination of aspects listed herein, the indicator material may include a side-chain crystalline polymer.

In another aspect of the present disclosure, which may be used in combination with any other aspect or combination of aspects listed herein, the microcapsules are configured to rupture in response to at least one of a predetermined force and heating above an activation temperature.

In another aspect of the present disclosure, which may be used in combination with any other aspect or combination of aspects listed herein, the activation temperature is in the range of −20 C-0 C, 0 C-100 C, 90 C-110 C, 100 C-200 C, or 100 C-300 C.

In another aspect of the present disclosure, which may be used in combination with any other aspect or combination of aspects listed herein, the activation temperature is greater than the temperature threshold.

In another aspect of the present disclosure, which may be used in combination with any other aspect or combination of aspects listed herein, a machine readable time-temperature exposure indicator label may include a substrate; a bar code symbol printed on substrate; a reservoir coupled to the substrate; a viewing area on the substrate; a transport structure providing fluid communication between the reservoir and the viewing area; an indicator material contained in the reservoir, the indicator material configured to liquefy at a predetermined temperature threshold, and once liquefied to travel along the transport structure from the reservoir to the viewing area, the passage of the indicator material from the reservoir to the viewing area requiring a predetermined time when the indicator material is maintained at the predetermined temperature threshold; and a plurality of ruptured microcapsules mixed with the indicator material in the reservoir.

In another aspect of the present disclosure, which may be used in combination with any other aspect or combination of aspects listed herein, the bar code symbol is an error correcting two-dimensional bar code.

In another aspect of the present disclosure, which may be used in combination with any other aspect or combination of aspects listed herein, the indicator material may also include colorant mixed with a meltable solid, wherein the colorant is transported with the meltable solid as the indicator material travels along the transport structure, and the colorant changes a color state of the viewing area when it is transported to the viewing area.

In another aspect of the present disclosure, which may be used in combination with any other aspect or combination of aspects listed herein, the bar code symbol has a symbology, and the viewing area is located within the bar code symbol, and the change in the color state of the viewing area causes a change in data in the symbology of the bar code symbol that is readable with a bar code scanner programmed to read the bar codes symbols with that symbology.

In another aspect of the present disclosure, which may be used in combination with any other aspect or combination of aspects listed herein, the transport structure is covered, so that passage of the colorant through the transport passage does not affect the data of the bar code symbol before the colorant reaches the viewing area.

In another aspect of the present disclosure, which may be used in combination with any other aspect or combination of aspects listed herein, the change of the color state of the viewing area does not change value of the bar code symbol in symbology of the bar code symbol, and the bar symbol encodes data that can be used to determine prior exposure to time-temperature by interpreting the color state of the viewing area.

In another aspect of the present disclosure, which may be used in combination with any other aspect or combination of aspects listed herein, the transport structure may further include a wick.

In another aspect of the present disclosure, which may be used in combination with any other aspect or combination of aspects listed herein, the transport structure may further include a microchannel.

In another aspect of the present disclosure, which may be used in combination with any other aspect or combination of aspects listed herein, the indicator material may further include f a polymer having side-chain crystallinity, an alkane wax, a gel, a protein, a polyurea formaldehyde, a polymelamine formaldehyde, a wax material, or an emulsion.

In another aspect of the present disclosure, which may be used in combination with any other aspect or combination of aspects listed herein, the indicator material may include a side-chain crystalline polymer.

In another aspect of the present disclosure, which may be used in combination with any other aspect or combination of aspects listed herein, an activatable machine readable time-temperature exposure indicator label may include a substrate; a bar code symbol printed on the substrate; a reservoir coupled to the substrate; a viewing area on the substrate; a transport structure providing fluid communication between the reservoir and the viewing area; and an indicator material encapsulated by microcapsules contained in the reservoir, the indicator material configured to liquefy in response to exceeding a predetermined temperature threshold, and wherein, while the microcapsules are intact, when the indicator material liquefies the microcapsules retain the indicator material in the reservoir, and when the indicator material is released from the microcapsules and liquefies, the liquefied indicator material travel along the transport structure from the reservoir to the viewing area, the passage of the indicator material from the reservoir to the viewing area requiring a predetermined amount of time when the indicator material is maintained at the predetermined temperature threshold.

In another aspect of the present disclosure, which may be used in combination with any other aspect or combination of aspects listed herein, the bar code symbol has a symbology, and the viewing area is located within the bar code symbol, and the change in the color state of the viewing area causes a change in data of the bar code symbol in the symbology of the bar code symbol that is readable with a bar code scanner programmed to read the bar code symbol with the symbology.

In another aspect of the present disclosure, which may be used in combination with any other aspect or combination of aspects listed herein, the transport structure is covered, so that passage of the colorant through the transport structure does not affect the data of the bar code symbol before the colorant reaches the viewing area.

In another aspect of the present disclosure, which may be used in combination with any other aspect or combination of aspects listed herein, the change of the color state of the viewing area does not change a value of the bar code symbol in a symbology of the bar code symbol, and the bar code symbol encodes data that can be used to determine prior exposure to time-temperature by interpreting the color state of the viewing area.

In another aspect of the present disclosure, which may be used in combination with any other aspect or combination of aspects listed herein, the microcapsules are configured to rupture and release the indicator material in response to application of a predetermined force.

In another aspect of the present disclosure, which may be used in combination with any other aspect or combination of aspects listed herein, the microcapsules are configured to be weakened by heating and then ruptured while heated by application of the predetermined force.

In another aspect of the present disclosure, which may be used in combination with any other aspect or combination of aspects listed herein, the microcapsules are configured to melt and release the indicator material without melting the indicator material.

In another aspect of the present disclosure, which may be used in combination with any other aspect or combination of aspects listed herein, an activatable time-temperature indicator label stock to indicate past exposure to an exposure temperature above a predetermined temperature threshold for at least a predetermined exposure time at the exposure temperature may include a substrate; a reservoir on or in the substrate containing an indicator material encapsulated in microcapsules, the indicator material configured to melt at the predetermined temperature threshold, the microcapsules, when intact, containing the indicator material in both its solid and melted state; a viewing area; a transport structure on or in the substrate, providing fluid communication between the reservoir and the viewing area; the indicator material, when liquefied and released from the microcapsules by rupturing of the microcapsules, flows from the reservoir to the viewing area; and the indicator material, when held at the predetermined threshold temperature, requires at least the predetermined exposure time to flow from the reservoir to the viewing area, wherein the microcapsules are configured to rupture in response to at least one of a predetermined force and heating above an activation temperature, the activation temperature being greater than the predetermined temperature threshold.

In another aspect of the present disclosure, which may be used in combination with any other aspect or combination of aspects listed herein, the indicator material includes or is mixed with a colorant which causes a change of a color state in the viewing area when the indicator material reaches the viewing area.

In another aspect of the present disclosure, which may be used in combination with any other aspect or combination of aspects listed herein, the indicator label may further include a cover concealing the reservoir and the transport structure, but allowing the viewing area to be observed.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a cross-sectional view of the layers of an activatable environmental exposure indicator, according to an example of the present disclosure.

FIG. 2 illustrates an environmental exposure indicator affixed to an article of manufacture, according to an example of the present disclosure.

FIG. 3 illustrates a cross-sectional view of a microcapsule containing an environmental indicator material, according to an example of the present disclosure.

FIG. 4 illustrates a micrograph view of microcapsules containing an environmental indicator material, according to an example of the present disclosure.

FIG. 5 illustrates a micrograph view of microcapsules containing an environmental indicator material after the occurrence of an activation event, according to an example of the present disclosure.

FIG. 6 illustrates a micrograph view of microcapsules containing an environmental indicator material after the occurrence of an activation event, according to an example of the present disclosure.

FIG. 7 illustrates a cross-sectional view of a microcapsule having two microcapsule shells and containing an environmental indicator material, according to an example of the present disclosure.

FIG. 8 illustrates a front view of a bar code layer having a bar code symbol, according to an example of the present disclosure.

FIG. 9A illustrates a front view of an environmental exposure indicator with an example color reference area, according to an example of the present disclosure.

FIG. 9B illustrates a front view of an environmental exposure indicator with an example color reference area, according to an example of the present disclosure.

FIG. 9C illustrates a front view of an environmental exposure indicator with an example color reference area, according to an example of the present disclosure.

FIG. 9D illustrates a front view of an environmental exposure indicator with an example color reference area, according to an example of the present disclosure.

FIG. 10A illustrates an activatable environmental exposure indicator in a non-activated configuration, according to an example of the present disclosure.

FIG. 10B illustrates an activatable environmental exposure indicator in an activated configuration after the microcapsules have ruptured, but prior to the environmental sensor being exposed to the corresponding predetermined environmental stimulus, according to an example of the present disclosure.

FIG. 10C illustrates an activatable environmental exposure indicator in an activated configuration after the microcapsules have ruptured, and after the environmental sensor being exposed to the corresponding predetermined environmental stimulus with an activation indicator material displaying the activation, according to an example of the present disclosure.

FIG. 11A illustrates an activatable environmental exposure indicator in an activated configuration after the microcapsules have ruptured, but prior to the environmental sensor being exposed to the corresponding predetermined environmental stimulus with an activation indicator material displaying the activation, according to an example of the present disclosure.

FIG. 11B illustrates an activatable environmental exposure indicator in an activated configuration with the environmental indicator material having been exposed to the predetermined environmental stimulus, according to an example of the present disclosure.

FIG. 12 illustrates an activatable environmental exposure indicator in various stages before and after exposure to an activation event with the bar code layer removed for clarity, according to an example of the present disclosure.

FIG. 13 illustrates an activatable environmental exposure indicator in various stages before and after exposure to an activation event, according to an example of the present disclosure.

FIG. 14 illustrates a method of monitoring exposure to time-temperature, according to an example of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

The present disclosure describes environmental indicators which include environmental indicator materials contained within microcapsules that may be activated by heat and/or pressure, e.g., using a thermal print head of a conventional or modified thermal printer to melt or rupture the microcapsules. These indicators may be provided using modified versions of thermal print media stock which include such indicator materials, so that, in some cases, the same thermal printer may be used both to print on the media and to activate, or selectively activate the environmental indicators. The indicator materials, microcapsules, and special label stock may be used for other types of activatable environmental exposure indicators, and particularly exposure indicators, such as radiation, oxygen, light, ultraviolet (UV), humidity, temperature, or simply the passage of time, as described in greater detail below.

Additionally, as environmental indicators and other types of temperature indicators gain broader use, it is desirable to allow them to be added to product labels or packaging (or customized if already present) at the time after the labels and/or packaging are manufactured. This allows for pre-labeled packages to provide dynamic data related to a host product's environmental exposure history in addition to the static data provided from a conventional bar code symbol. This capability can be provided without altering the process by which bar codes are provided on packaging or labels, or alternatively may be provided at a different point in the supply chain, for example at a different time and/or place than when/where bar codes are provided on the packaging.

Conventional bar code symbols contain information that is static; the information is encoded in the bar code symbol in a manner specified by the symbology of the bar code symbol, which is usually specified by a standard so that all users of the bar code symbol, including those making printers and readers can all work compatibly. As conventional bar code symbols contain static data and environmental exposure indictors contain dynamic data, the two can be combined to provide more complete information regarding a product. When an environmental exposure indicator is placed together with the bar code, e.g., overlapping, adjacent, under or over, depending on the configuration, the static and dynamic data can even be read simultaneously by one scanning device, e.g. a modified conventional bar code scanner. The present disclosure provides a printing stock which includes an activatable environmental indicator material. After the environmental indicator material is provided, the printing stock may be overprinted by a bar code symbol at any convenient point in the product manufacture, production, or distribution process. This may be near, adjacent, or even over the environmental indicator material.

A need exists for the ability to effectively convey both static and dynamic data on a product without scrapping existing product label and packaging printing and production processes. An approach for combining the static data encoded into the bar code with dynamic data such as information regarding the environment to which the product has been exposed is presently disclosed.

Further, a need exists for an activatable medium that is easily employed by an end-user and provides efficient, on-demand activation during the printing of labels containing environmental exposure indicators of various types.

The present disclosure describes environmental exposure indicators (including indicators that simply show the passage of time) which may be provided as part of a printable medium, such as printable webs, paper, or other print stocks. The indicators may be provided initially in an inactive state, so they tend not respond to the environmental stimulus of interest. This may be accomplished, e.g., by having an indicator which indicates exposure to the environmental stimulus by the reaction of two or more components that are physically separated prior to activation, e.g., removal of a barrier separating the reacting components. In this manner, the environmentally sensitive indicators may be provided as part of a special print stock that may be printed and activated at some time later than its initial manufacturing, e.g., during a printing process that is also printing conventionally on the print stock. Another approach may be to encapsulate the environmental indicator materials (e.g., in microcapsules) to prevent the environmental indicator materials and/or environmental sensors including the environmental indicator materials from reacting to the environment when the response condition is satisfied and to selectively activate the indicator materials and/or the environmental sensor including the environmental indicator material by rupturing the encapsulation to release the indicator materials as described herein and in related applications: U.S. patent application Ser. No. 18/369,520, titled “MEDIA PROCESSING DEVICE AND COMPONENTS FOR ACTIVATABLE MEDIA PLATFORMS”, filed on Sep. 18, 2023; U.S. patent application Ser. No. 18/369,536, titled “MEDIA CONSTRUCTION TO FACILITATE USE OF ACTIVATABLE PLATFORM”, filed on Sep. 18, 2023; U.S. patent application Ser. No. 18/369,506, titled “USE OF ENCAPSULATED POLAR PROTIC CHEMISTRIES FOR RFID TEMPERATURE MONITORING”, filed on Sep. 18, 2023; U.S. patent application Ser. No. 18/369,548, titled “RIBBON FOR USE IN PRODUCING PRINTER ACTIVATABLE INDICATORS”, filed on Sep. 18, 2023; and U.S. patent application Ser. No. 18/369,498, titled “PRINTER ACTIVATABLE ENVIRONMENTAL SENSING THROUGH CHEMICAL ENCAPSULATION”, filed on Sep. 18, 2023.

As used herein, the term “activation event” is a treatment, e.g., the exposure to certain amount of heat and/or pressure that causes the activation material, or environmental indicator material, to operate. The activation event may include the application of heat to cause the activation material to reach a predetermined activation temperature, a predetermined activation pressure, or a combination thereof. The use of applied heat may reduce the amount of pressure required for activation as compared to activation without applied heat, or vice versa.

As used herein, the term “non-activated configuration” refers to a configuration in which the microcapsules fully encapsulate the environmental indicator material inhibiting the operation of the environmental indicator material so that the environmental indicator material will not respond, or will respond only in a materially reduced manner, to the relevant predetermined environmental stimulus. The “activated configuration” refers to a configuration in which the environmental indicator material is no longer fully contained within the microcapsules such that the environmental indicator material will respond in its intended fashion to the relevant predetermined environmental stimulus, e.g., depending on the type of environmental indicator material, either immediately upon exposure beyond a threshold condition, or over time, or over time at a rate dependent on amount of exposure.

As used herein, the term “activation device” is a device configured to selectively cause the microcapsules to transition from their non-activated configuration to its activated configuration.

As used herein, the term “print head” refers to a component of an activation device that transfers heat and/or pressure to an activatable print medium in response to an instruction from the activation device. In some embodiments, the print head may be part of a direct thermal printer, e.g., a direct thermal bar code printer.

As used herein, the term “predetermined environmental stimulus” is an environmental condition in which the environmental indicator material is configured to respond. The predetermined environmental stimulus may include, but is not limited to, temperature excursion above a predetermined temperature threshold, temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time. In some embodiments, a predetermined environmental stimulus may be a predetermined temperature threshold.

As used herein, the term “environmental indicator material” refers to a material that exhibits a detectable response after being released from the microcapsules when it is exposed to a predetermined environmental stimulus. The detectable response may include a color state change, a change in transparency, a change in hue, a change in an electrical property, a change in conductivity, a change in capacitance, movement of the environmental indicator material along a substrate, or combinations thereof. In some embodiments, the environmental indicator material is configured to undergo a continuous chemical or physical state change between an “initial state” and an “end state”. In some embodiments, the change of state may be a change in a property, e.g., an optical property, such as a reflectance value, saturation value, color value, color density value, optical density value or color hue value of the “reactive component” or an electrical property. Specifically, the state change (e.g., optical property change) may provide exposure information indicating an exposure to an environmental stimulus since the environmental exposure indicator was in the “activated configuration.”

As used herein, “static data” refers to fixed data values encoded on a bar code that do not change over time or in response to environmental exposure. These data values may include information referencing a product whose label or package includes the bar code, e.g., Stock Keeping Units (“SKUs”) or predetermined expiration dates. In this regard, static data contains no information directly related to the environment in which the bar code or product bearing it is actually kept.

As used herein, “dynamic data” refers to data values that change over time. This may include data regarding an environment exposure history such as temperature, humidity, light exposure, radiation exposure, and the like. Dynamic data can be captured through environmental exposure indicators applied to a perishable host product to track the product's exposure to an environmental condition. For example, (i) temperature sensitive products, such as frozen food product(s) may include an environmental exposure indicator that tracks the food product's exposure to temperatures above freezing, (ii) light sensitive products, such as film product(s) may include an environmental exposure indicator that tracks the film product's exposure to UV light, (iii) moisture sensitive products, such as semiconductors and other electronic product(s) may include an environmental exposure indicator that tracks the electronic product's exposure to humidity, etc. Access to dynamic data can be valuable in a variety of industries including, but not limited to, shipping, pharmaceuticals, and agriculture, e.g., in cold chain management.

### Activation Using Thermal Printer or Other Device

A conventional thermal printing technology for printing dataforms or images, such as bar code symbols and/or text, is direct thermal printing. A direct thermal printer does not use a ribbon, but instead the printable media itself is the thermal media. The direct thermal media is manufactured or coated with a thermochromic material that changes color when exposed to sufficient heat, such as a leuco dye, which switches from a first chemical form that is colorless to a second chemical form that is black or colored. The web of direct thermal media is pressed against and moved past a thermal print head. The thermal print head receives data of a rendered bitmap and heats specific heating elements of the print head according to the data.

To print labels or other documents, a thermal printer may use a thermal print head comprising a row of addressable heating elements to heat a thermal media. The elements are small compared to the image to be printed; e.g., 8, 12, or 24 elements per mm are typical, and other resolutions, are commercially available. This differs from thermal inkjet printers which use addressable heaters to heat an ink or wax that is dropped or ejected to a document or other printable media.

Heat from the heated elements causes the thermochromic material on the printable media to transition from colorless to black or from colorless to colored. Print head heating elements which are not heated do not cause a color transition. In some direct thermal media, a first zone of the printable media includes thermochromic material that transitions from colorless to a first color while a second zone of the printable media includes thermochromic material that transitions from colorless to a second different color. Some direct thermal media comprises a multi-layer arrangement including a first layer of a first color and a second non-transparent layer of a second color. For the multi-layer arrangements, heat from the heated print head elements cause the second layer to transition to a transparent state revealing the color of the first layer.

Conventional print media may be used as a carrier to hold the environmental indicator materials which then may be activated using an activation device, e.g., a thermal printer. The conventional print media backing may be placed either underneath the transparent upper layers or on the bottom most portion of the environmental indicator beneath the activatable portion, or applied as an additional layer over top of the print media, or incorporated as an element of an existing layer by modifying the process for manufacturing the conventional print media. Additionally, certain layers of the environmental indicator may also include conventional printer media elements as a supportive substrate.

In addition to the media being printable with a conventional thermal printing process, the activatable environmental sensor print medium is activatable as a result of exposure to temperature or by force applied to the medium, such as pressure or shear e.g., from heat and pressure applied using the conventional thermal print head. The microcapsules on or embedded in the print media or other substrate may be configured such that the activatable environmental sensor print media is sensitive to high temperature the application of pressure. As result of exposure to a sufficiently high temperature or pressure, the configuration of the layers of the activatable environmental sensor print media may be altered. While layers are shown, it will be appreciated that approaches may be employed, e.g., using walls that prevent lateral movement of reactants that are broken by activation. The materials and thermal print head may be tuned, so that the activation takes place at the same, lower, or higher temperature than the conventional thermal printing process. As a result of the configuration of the layers of the activatable environmental sensor print media being altered, the activatable environmental sensor print media is activated, and may then operate as an environmental exposure indicator, which is configured to provide an indication of the historical exposure of the activatable environmental sensor print media to the predetermined environmental stimulus that occurs after activation. In indicators where thermal print regions and activatable indicator overlap, it may be advantageous to have materials with significantly different response characteristics, so that the conventional printing and activatable media can each be triggered without activating the other, e.g., one may require a higher temperature to be triggered, while the other responds to a lower temperature but requires a longer exposure time. Alternatively, the materials may be placed in different areas of the printable medium.

### Activatable Environmental Exposure Indicator

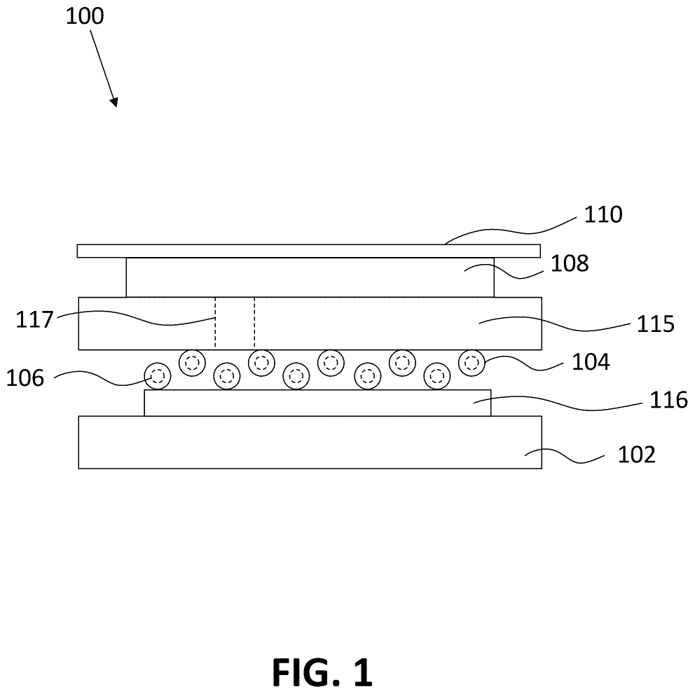

FIG. 1 illustrates a cross-sectional view of the layers of an example activatable environmental exposure indicator 100. Optionally, the indicator may contain conventional elements of a thermal print media, e.g., it may be constructed by adding environmental indicator components to a conventional thermal print media components, so that the indicator can still be printed using a conventional thermal printing process. Optionally, the medium may have a predetermined pattern, with conventional thermal print media structure in some predetermined locations, and with environmental indicator materials and microcapsules in other locations. Alternatively, the conventional print media elements and environmental indicators may, in some cases overlap.

The activatable environmental exposure indicator 100 may include a base substrate 102, microcapsules 104 containing an environmental indicator material 106, a bar code symbol 108 affixed onto a bar code layer 115. In some embodiments, the bar code layer 115 may be omitted and the bar code symbol 108 may be printed directly onto the base substrate 102. In some embodiments, a clear overlaminate film 110 may be included. The clear overlaminate film may be placed between the environmental indicator material 106 and the bar code layer 115, or alternatively, atop the bar code layer 115.

The activatable environmental exposure indicator 100 may have a thickness in a range of about 0.10 mm to about 0.20 mm, from about 0.01 mm to about 0.10 mm, from about 0.10 mm to about 0.20 mm, from about 0.10 mm to about 0.40 mm, from about 0.10 mm to about 1.50 mm, or from about 1.50 mm to 2.00 mm.

The substrate 102 and/or bar code layer 115 may be a printable substrate, e.g., a web material, e.g., paper such as a cellulose paper, polymer film substrate, a metallic layer, such as a metallic aluminum layer or an absorbent substrate. In some examples, the substrate 102 may have a thickness in a range of about 0.10 mm to about 0.20 mm, from about 0.01 mm to about 0.10 mm, from about 0.10 mm to about 0.20 mm, from about 0.10 mm to about 0.40 mm, from about 0.10 mm to about 1.50 mm, or from about 1.50 mm to 2.00 mm. The substrate 102 may be one of a Polyolefin, polyamide, polypropylene, polyester polyimide, Polyart synthetic paper, nylon, or PPG Teslin paper. In an example, there may be a topcoat applied to the substrate 102 and/or the bar code layer 115. Optionally, the environmental exposure indicator 100 may further include a release liner and/or an adhesive backing to allow the activatable environmental exposure indicator 100 to be selectively attached to surfaces, e.g., as a label. Depending the application, the activatable environmental exposure indicator 100 may be provided as a continuous web of material (containing multiple indicators) that may be cut, or that may be perforated for easy separation into individual indicators, or as precut label print stock in a desired form factor. In some methods as described further below, information may be printed onto the label print stock to product a printed label. The information may be printed using a direct thermal printer which may also apply the activation event required to activate the microcapsules 104.

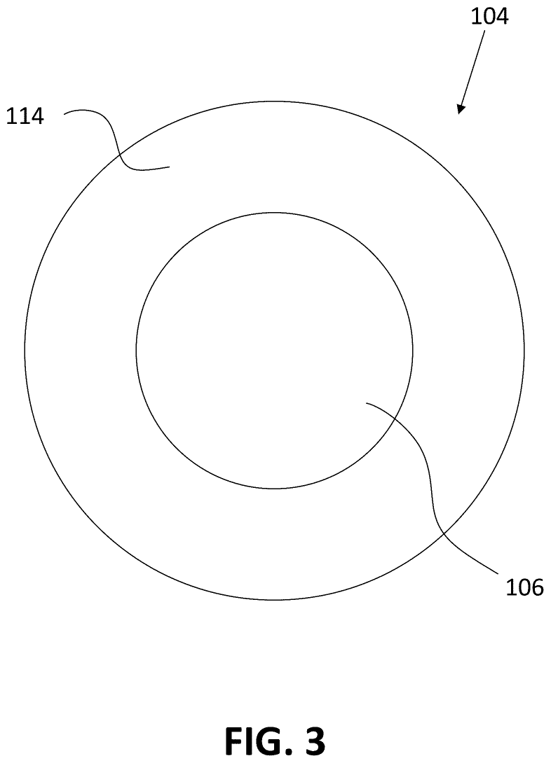

Atop or embedded within the substrate 102 are the microcapsules 104 containing the environmental indicator material 106 (shown in FIGS. 1 and 3). The microcapsules 104 can be selectively disposed on the substrate 102 in designated area(s) and/or can be disposed on the substrate 102 to generally coat the substrate 102. In some embodiments, the microcapsules 104 may be deposited into a reservoir. In some embodiments, the microcapsules 104 can be disposed onto a transport structure such as a wick 116 or a microchannel, as described further below. In some embodiments, the microcapsules 104 can be disposed onto the substrate and a transport structure such as the wick 116 can be disposed over the microcapsules 104 and substrate 102 such that the microcapsules 104 are disposed between the substrate 102 and the transport structure.

There are a plurality of methods to deposit the microcapsules 104 onto the substrate 102 and/or transport structure. One method is a drawdown coating method. The method includes applying the microcapsules 104 along a width of the substrate 102 and then spreading the microcapsules 104 along the substrate 102 with a drawdown rod. The drawdown rod spreads the microcapsules 104 along the substrate 102 to a thickness to form a transfer layer of the microcapsules 104. The microcapsules 104 can then dry to the substrate 102. In at least one aspect, the microcapsules 104 are added to a wax layer and applied to the substrate 102 using the drawdown coating method. In certain embodiments, other methods of manufacture may be used. Flexographic printing cylinders and rollers may be used to coat material onto the substrate 102, then the substrate 102 may be cut and/or wound for loading into a printer. Retransfer methods may also be used, such as ink jetting material onto the substrate 102 or depositing the microcapsules 104 on the substrate 102 using a thermal transfer apparatus. Yet other methods such as powder deposition (as disclosed in U.S. patent application Ser. No. 18/385,704, titled “METHODS AND SYSTEMS FOR MAKING ENVIRONMENTAL SENSORS UTILIZING POWDER DISPENSING TECHNIQUES”, filed on Oct. 31, 2023) and gel screen printing (as disclosed in U.S. patent application Ser. No. 18/516,510, titled “SYSTEM AND PROCESS FOR PRINTING ENCAPSULATED AND NON-ENCAPSULATED MATERIALS UTILIZING GELLING AGENTS”, filed on Nov. 21, 2023) in may be used to deposit the microcapsules onto the substrate 102 and/or transport structure.

In some embodiments, the clear overlaminate film 110 can isolate and/or protect the microcapsules 104. The clear overlaminate film 110 is an overlay component that overlays at least the microcapsules 104 and substrate 102. In some embodiments, the clear overlaminate film 110 may be between the microcapsules 104 and the bar code layer 115. In other embodiments, the clear overlaminate film 110 may be atop the bar code layer 115. The overlaminate film 110 may be one of Fasson Faslam clear polypropylene, Avery Dennison® DOL series vinyl (PVC), any conformable overlaminate films, Apco PET or BOPP overlaminate films. The clear overlaminate film 110 allows a user to view through the clear overlaminate film 110 to see the layers below including the substrate 102, microcapsules 104, and/or at least a portion of a transport structure while isolating and/or protecting the layers such that the layers (e.g., the substrate 102, microcapsules 104, and/or at least a portion of the transport structure) can be seen, but not touched. Depending on the desired application, the clear overlaminate film 110 may optionally be ultraviolet (UV) blocking, water resistant, hermetically sealed, chemically resistant, or merely a barrier to physical abrasion to protect the layers below the overlaminate film 110.

The overlaminate film 110 may be affixed to the substrate 102 by an adhesive. Particularly, if the adhesive is used across the surface of the overlaminate film 110, a transparent adhesive may be needed. In some embodiments, the adhesive is applied directly to the substrate 102. In other embodiments, the adhesive is pre-placed as an adhesive backing on the substrate 102. In this example, the adhesive may cover the entire substrate 102 or only a portion of the substrate 102. The adhesive may include, for example, an aqueous emulsion adhesive, an acrylic polymer or co-polymer, an amine salt of an acrylic co-polymer, a carnauba wax, a candelilla wax, a hydrocarbon wax, Neocryl A-1052, Neocryl BT-24, Neocryl B-818, Epotuf 91-263, Ottopol 25-50E, Ottopol 25-30, Joncryl 682, or Joncryl 538A. The adhesive can be attached manually by an operator, or by a machine. In some embodiments, the adhesive may be placed on a release liner to adhere to the substrate 102.

Atop the microcapsules 104, is the bar code layer 115 having the bar code symbol 108, as described further below. A bar code symbol 108 is a visual representation of static data. Bar code symbols can be either one-dimensional (“1D”) and represent data by varying the width and spacing of lines, or two-dimensional (“2D”) by varying the height, width, and spacing of smaller components such as pixels. Black and white 2D bar codes can represent more data per unit area than 1D bar codes. It should be appreciated that the following detailed description may apply to both 1D and 2D bar codes. Even though several of the illustrative examples described herein refer to 2D bar codes, the described techniques and features may also similarly apply to 1D bar codes.

In some embodiments, the bar code layer 115 may be placed atop the clear overlaminate film 110. The bar code layer 115 is a cover concealing at least part of the transport structure while also including a viewing area 117 that allows at least part of the transport structure to be observed. The bar code layer 115 may be any material suitable for displaying the microcapsules 104 and environmental indicator material 106, e.g., porous materials for bar codes printed using inks, etchable materials for laser-etched bar codes, paper, nylon, vinyl, other synthetic polymers such as polytetrafluoroethylene (“PTFE”), or other materials that are suitable for receiving and displaying the microcapsules 104 and environmental indicator material 106 contained within the microcapsules 104. The bar code layer 115 may, for example, be paper or film (e.g., nylon, vinyl, synthetic polymer material, carbon fiber, Teslin synthetic paper, polyethylene (“PE”), polypropylene (“PP”), polytetrafluoroethylene (“PTFE”), polyester, polyethylene, polyolefin, polyimide, vinyl, acrylic film, polypropylene, non-woven nylon, coated and non-coated direct thermal paper, printable polyethylene terephthalate (“PET”), oriented polypropylene (“OPP”), biaxially oriented polypropylene (“BOPP”).

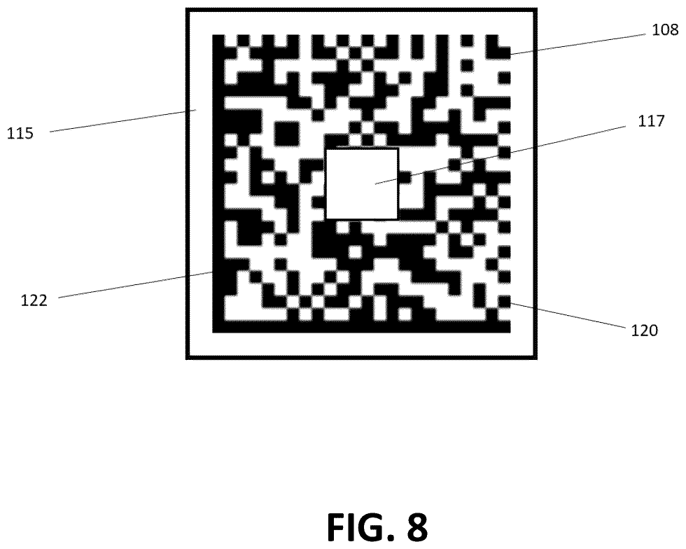

Additionally, the bar code layer 115 may include the viewing area 117 (e.g., as shown in FIG. 8), or an area within the bar code symbol 108 that exposes the environmental indicator material 106, as described further below. As shown in the illustrated embodiments, the viewing area 117 may be circular or rectangular, though it will be appreciated that these shapes are merely exemplary and other configurations of the viewing area 117 may exist. As described below, the bar code symbol 108 can still be read by a scanning device even with the inclusion of the viewing area 117. The symbology of bar code symbol 108 with the viewing area 117, and the location of the active color-changing regions with respect to the underlying static bar code symbol 108 can be configured and interpreted using methods described in U.S. Pat. No. 10,546,172 to Temptime Corporation, a Zebra Technologies company.

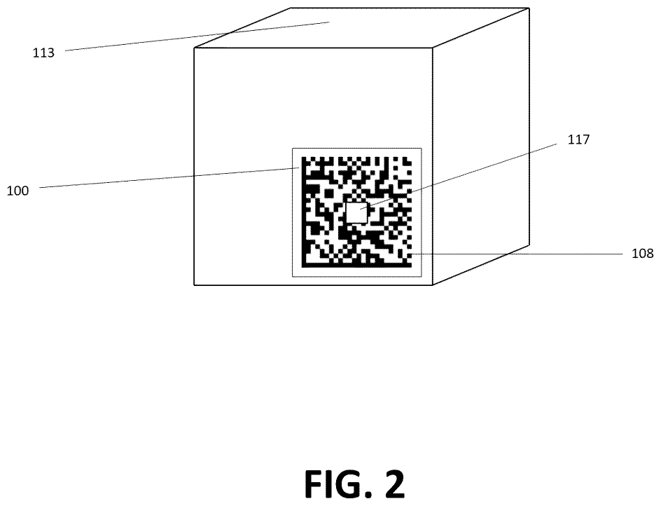

FIG. 2 illustrates an example environmental exposure indicator 100, as previously described in FIG. 1, affixed to an article of manufacture. The article of manufacture 113 containing a perishable host product is shown in FIG. 2. The article of manufacture may be a package, box, bag, label, container, or other exterior surface. Even though several of the illustrative examples described herein refer to packages, the described techniques and features may also similarly apply to any other article of manufacture. In this example, a bar code symbol 108 is included on the environmental exposure indicator 100 to include additional data related to the perishable host product. The environmental exposure indicator 100 can be placed onto the package and is configured to exhibit a change in property in response to both an activation event and a predetermined environmental stimulus to indicate that the article of manufacture has been exposed to a predetermined environmental stimulus beyond a predetermined specified exposure limit which can be detected through the viewing area 117. The viewing area 117 may include in at least a portion of the bar code symbol 108 such that when the bar code symbol 108 is scanned by a scanning device, the data received by the scanning device may vary, as described further below.

### Microcapsules

FIG. 3 illustrates a cross-sectional view of a microcapsule 104 wherein the microcapsule 104 contains a shell 114 encapsulating the internal environmental indicator material 106. The microcapsule 104 may be any size, but in one such embodiment, has an outer diameter length between 50 to 250 μm. The shell 114 of the microcapsule 104 may have any thickness, but in one such embodiment, has a thickness of between 5 to 25 μm. The payload, or the ratio of the total weight of the environmental indicator material 106 within the microcapsule 104 to the entire weight microcapsule 104 including the environmental indicator material 106 contained within the microcapsule 104, can range from 50% to 90%. It will be appreciated that a variety of microcapsule shell 114 materials may be chosen, depending on the application, the type of activation, and the nature of the environmental indicator material 106. In general the microcapsules 104 should resist the passage, whether by flow, diffusion, or migration, of the environmental indicator material 106 prior to activation. For example, the microcapsules 104 may be a wax, e.g., an alkane wax, or other acid resistant compound having a relatively high melting point, e.g., fatty acid amide, an ester or Elvax EVA resin. For example, the melting point may be in a range of about 50° C. to about 300° C., from about 100° C. to about 300° C., from about 150° C. to about 300° C., from about 200° C. to about 300° C., from about 250° C. to about 300° C.

In another example, the microcapsules 104 may be polymer coating having a high glass transition temperature (Tg) e.g. polysulfone. For example, the glass transition temperature may be in a range of about 50° C. to about 300° C., from about 100° C. to about 300° C., from about 150° C. to about 300° C., from about 200° C. to about 300° C., from about 250° C. to about 300° C. For example, polysulfone, with a Tg of about 190 C may be used. In additional examples, the microcapsules 104 may be one of Styrene Maleic Anhydride (SMA), Polyphenylene Ether (PPE), Cellulose Acetate, Cellulose Diacetate, Polyarylate, Polyamide, Polycarbonate, polyether ether ketone, Polyether Sulfone, PET, PFA, polymethyl methacrylate (PMMA) or Polyimide. In another example, the microcapsules 104 are a low molecular weight polymer gel having a high melting point, e.g., fatty acid amide, an ester or Elvax EVA resin. For example, the melting point may be in a range of about 100° C. to about 300° C., from about 150° C. to about 300° C., from about 200° C. to about 300° C., from about 250° C. to about 300° C. Additionally, in some examples, the polymer gel has a molecular weight in a range from about 1 g/mol to 100,000 g/mol, from about 3,500 g/mol to 6,000 g/mol and from about 200 g/mol to 2,000 g/mol. Alternatively, the microcapsules 104 may be a gel, gelatin, protein, polyurea formaldehyde, polymelamine formaldehyde, wax material, melamine, or an emulsion. The microcapsules may be available in wet and dry formulations. Polymelamine and polyurea formaldehyde can both be used for encapsulations via interfacial polymerization, which uses two immiscible phases. Once separated in the same vessel, a reaction is initiated at the interface of the two immiscible phases in the presence of an initiator and the material to be encapsulated. As polymerization occurs, microcapsules form around the core material. The microcapsule 104 releases the environmental indicator material 106 upon rupturing the microcapsule 104.

FIG. 3 illustrates the microcapsule 104 initially in an unactivated form, capable of being configured to transition to an activated form when activated through exposure to an activating event, e.g., the heat, pressure, and/or heat and pressure of a thermal print head. In the unactivated form, the microcapsule 104 maintains separation between the environmental indicator material 106 and any external environmental stimuli and/or contains a response of the environmental indicator material 106 in response to any external environmental stimuli.

The activatable environmental exposure indicator 100 may be activated through exposure of the microcapsules 104 to an activation event. The activation event may cause the fracturing, melting, breaking, dissolving, subliming, or becoming porous, allowing the release of its contents. For example, the activation event may be an application of at least one of an activation temperature and an activation pressure. In some examples, the microcapsule 104 may be selectively activated, e.g., by activating only a portion of the microcapsules, the microcapsules in particular locations. In some examples, the temperature threshold for activation may be from about −20° C. to 0° C., from about 0° C. to 100° C., from about 0° C. to 300° C., from about 90° C. to 110° C., from about 100° C. to 200° C., from about 100° C. to 300° C., and from about 200° C. to 300° C. Activation may be achieved by applying a high temperature for a very short interval, e.g., a few milliseconds. In this manner, even if the temperature needed to activate the device exceeds the temperature that a temperature exposure indicator is configured to indicate, the exposure may be so short that the environmental indicator material itself is not affected. For example, the mass or heat of fusion of the environmental indicator material may be much greater than the mass or heat of fusion of a barrier that needs to be removed, allowing a short exposure to high temperature to remove or alter the microcapsule 104 without significantly affecting the environmental indicator material 106 itself. Typical thermal print heads have temperatures in the range from about 100° C. to 300° C., which may be tuned downward for select applications to from about 100° C. to 200° C. They are typically exposed to the thermal print heads for a brief period of time, for example a few milliseconds. The microcapsules 104 itself responds when it reaches a temperature of in a range from about −20° C. to 0° C., from about 0° C. to 100° C., from about 0° C. to 150° C., from about 0° C. to 50° C., from about 0° C. to 300° C., from about 50° C. to 100° C., from about 90° C. to 110° C., from about 100° C. to 150° C., from about 100° C. to 200° C. It will be appreciated that the activation temperature ranges given are purely exemplary and the microcapsules 104 can be formed to response to other temperature ranges. In some cases, pressure may also contribute to the activation, e.g., by breaking microcapsules 104, either alone like an impact printer, or in combination with elevated temperature. In some examples, the activation pressure required to activate the microcapsules 104 may be from about 1.5 to 8 pounds per square inch or from about 4 to 15 pounds per square inch. In some instances, the microcapsules 104 may be exposed to heat and pressure from a direct thermal printer (e.g., such as a Zebra ZT100 printer) or other thermal printer, applying a pressure of approximately 8 pounds per square inch and a temperature of 300° C. As an example, the ZT100 direct thermal printer can apply between 4 to 20 pounds per square inch and heat a material up to about 320° C. It will be appreciated that the activation pressure ranges given are purely exemplary and the microcapsules 104 can be formed to respond to other pressure ranges.

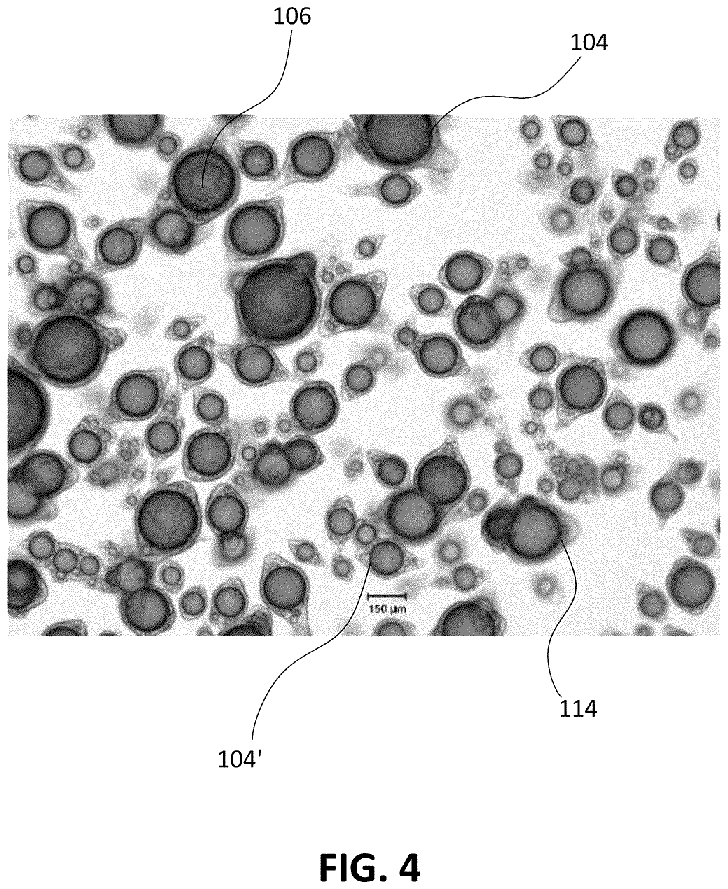

FIG. 4 illustrates a micrograph including one example of microcapsules 104 according to the present disclosure. In this example, the microcapsules 104 contain an environmental indicator material 106 such as those described below. The shell 114 of the microcapsule 104 may be any material as described above. The microcapsules 104 vary in size, but one such microcapsule 104′ is approximately 150 μm. There are microcapsules 104 that are both bigger and smaller than 150 μm.

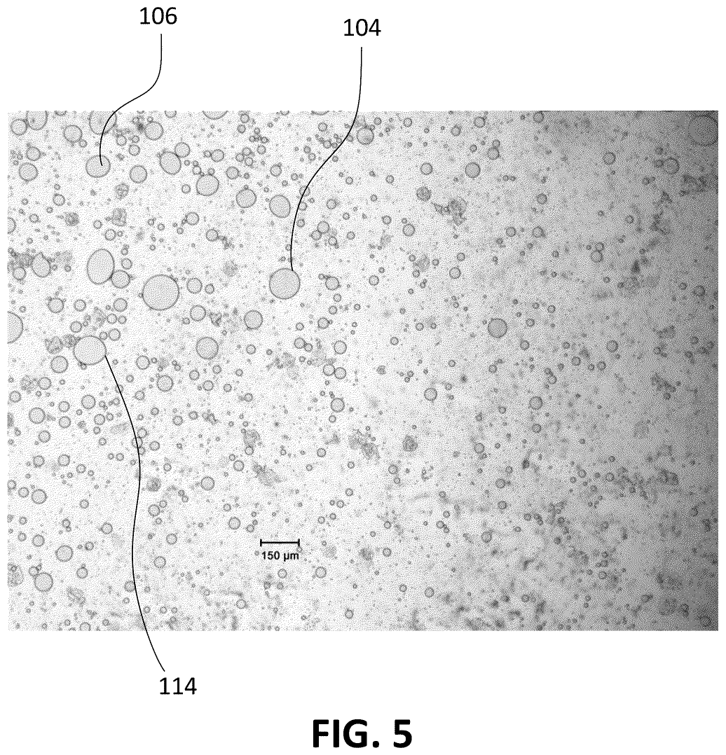

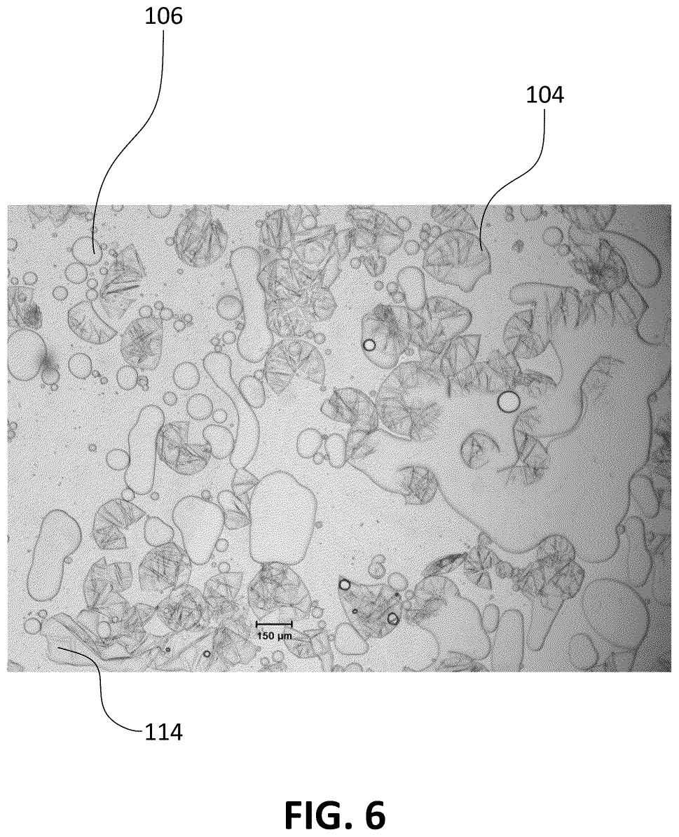

FIG. 5 illustrates another micrograph including another example of microcapsules 104 according to the present disclosure. In this example, the microcapsules 104 contain an environmental indicator material 106 such as those described below. The shell 114 of the microcapsule 104 may be any material as described above. The microcapsules 104 vary in size, but no microcapsule 104 exceeds approximately 150 μm. FIG. 6 illustrates a micrograph of the microcapsules 104 of FIG. 5 after exposure to an activation event.

In some examples, exposure to an activation event, the application of at least one of a heat and pressure, causes the microcapsules 104 to undergo a phase change and at least one of (i) flow away, (ii) sublimate, or (iii) become porous. In some examples, this may even result in complete or near-complete removal of the microcapsules 104. In other cases, portions of the microcapsules 104 may remain, e.g., as a porous layer that allows diffusion of the environmental indicator material 106.

The activation event may be carried out using an activation device. In some examples, the activation device may be a device that includes a processor, a memory coupled to the processor and a thermal print head, e.g., a conventional thermal printer with software modifications.

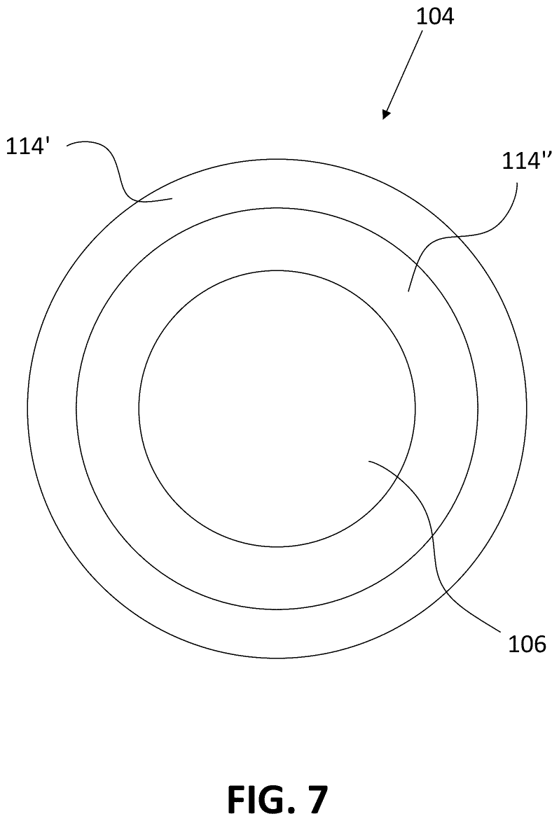

In some embodiments, there may be two or more shells 114 within a microcapsule 104 providing a barrier to the environmental indicator material 106. FIG. 7 shows an embodiment with two separate shells, 114′, 114″, encapsulating the environmental indicator material 106. Each shell 114′, 114″ may be configured to respond to a different activation event thus ensuring that the environmental indicator material 106 is only released after or in response to exposure to specific activation events. As one example, the first shell 114′ may be configured to respond to a certain activation pressure otherwise insulating the second shell 114″ from exposure to a certain activation temperature to which the second shell 114″ responds. As one example, the first shell 114′ may be configured to respond to a first activation pressure and/or temperature and the second shell 114″ may be configured to respond to a second pressure and/or temperature that is higher than the first pressure and/or temperature. In this regard, the utilization of multiple shells can tailor the order of conditions to which the environmental indicator material 106 be exposed in order to activate.

There are many approaches to create the microcapsules 104 encapsulating the environmental indicator material 106. One such approach involves emulsifying materials such as a gel, gelatin, protein, polyurea formaldehyde, polymelamine formaldehyde, wax material, melamine, or an emulsion into an outer shell material. The environmental indicator is placed in the center of a disk. The outer shell material is then pumped into the center of a disk. The core material, such as an environmental indicator material 106, is surrounded by the outer shell 114 formed by the outer shell material as it enters the disk. The disk may have a plurality of nozzles on an exterior surface of the disk. The nozzles are connected to the center of the disk. The disk acts as a centrifuge and is rotated in a direction to produce microcapsules 104 with a narrow particle size distribution. Because of the centrifugal force exerted on the microcapsules, particles of certain sizes are thus separated. The microcapsule 104 size can be controlled by altering the rotation speed of the disk to produce larger or smaller particles. The microcapsules 104 have an outer shell material that surrounds a core material.

Alternative approaches to production of the microcapsules may include EHD coextrusion, stationary coextrusion, submerged nozzle coextrusion, pan coating, vibrating nozzle, centrifugal coextrusion, fluid bed coating, spray drying, rotating disk, in situ polymerization, solvent evaporation, interfacial polymerization, phase separation, simple coacervation, complex coacervation, sol-gel methods, liposomes, and nanoencapsulation.

### Environmental Indicator Material

The present disclosure includes an environmental indicator material 106 encapsulated in the microcapsules 104, e.g., as shown in FIGS. 3 and 7. The microcapsules 104 may be utilized in order to prevent wicking, or migration, of the environmental indicator material 106 prior to an activation event even when the environmental indicator material 106 encapsulated in the microcapsules is exposed to a predetermined environmental stimulus (e.g., temperature or light). Alternatively, the microcapsule 104 may insulate the environmental indicator material 106 from a predetermined environmental stimulus (e.g. exposure to a particular gas, humidity, or light).

The environmental indicator material 106 may be any such material capable of exhibiting a detectable response upon the occurrence of a predetermined environmental stimulus, e.g., a material that when released interacts with another material to cause a change in color state, a material that liquefies and moves from its current location to another, a material that interacts with an electrical component to change an electrical property, etc. In some embodiments, the environmental indicator material 106 may be a thermochromic material, an alkane wax, dyed waxes, hydrochromic inks, specialized chemistry, polymer chemistry, polymers having side-chain crystallinity, and/or other phase change materials.

Most importantly, the environmental indicator material 106 is able to be tailored to change from at least a first material state to a second material state in response to a predetermined environmental stimulus. The material state may be a state of matter, e.g., changing from solid to liquid, a change in viscosity, how a material flows, color state, a transparency level, a hue, an electrical property, a conductivity, a capacitance, a distance the environmental indicator material 106 has traveled along the substrate, and combinations thereof. It will be appreciated that the above-mentioned material states are purely exemplary and other material state changes may exist. The response is detectable which may for example mean that it may be optically readable by a scanning device or readable by a human. It also may provide other detectable responses, e.g., a change in electrical property. The readability and human visibility of the environmental indicator material 106, in some examples, may only be detectable in one of the environmental indicator material's material states; for example the material may be transparent and effectively invisible in one state and have a readily visible opaque color in another state.

In some embodiments, there may be combinations of different environmental indicator materials 106 contained within microcapsules 104. This may include multiple types of microcapsules 104 containing multiple types of environmental indicator materials 106. The different environmental indicator materials 106 may be placed into microcapsules 104 to keep the environmental indicator materials 106 from pre-mature contact with each other, with a layer of an activatable environmental sensor print medium (e.g., the activatable environmental exposure indicator 100), with a wick (e.g., wick 116).

In one embodiment, the environmental indicator material 106 can also include an activation marker material, which upon release from the microcapsules 104 in response to an activation event can provide an indication that the microcapsules 104 have been place in the activated configuration. Such an indication may or may not be visible to the human eye and/or may or may not be distinguished from the indicator material 106 that provides a detectable response to a predetermined environmental stimulus. As an example, the activation marker material can include a dye having a predetermined color, a luminescent material, and/or a photochromic material. In some embodiments, microcapsules 104 can be deposited in an activation indicator area of the printable medium, where these microcapsules 104 include the activation marker material, and microcapsules 104 including the environmental indicator material 106 can be deposited in an environmental indicator area. In some embodiments, the activation indicator area and the environmental indicator area can be positioned in proximity and/or adjacent to each other. By positioning the activation indicator area in proximity and/or adjacent to the environmental indicator area, the activation indicator area and the environmental indicator area can experience an activation event in a similar manner, e.g., both areas can experience the same or nearly the same activation temperature and/or activation pressure. For example, if an environmental indicator material 106 is black when exposed to the relevant environmental stimulus, but transparent initially, a person will not be able to tell, at a glance that the device has been activated. By adding a yellow dye to at least some microcapsules 104, the area will turn yellow when activated, thereby making it clear to a user that the device has been activated, but without confusing the user that the relevant environmental exposure has occurred.

In one embodiment, the environmental indicator material 106 is a meltable solid configured to melt in response to a predetermined temperature above a threshold, forming a liquid that migrates along the substrate 102 for at least a predetermined distance when remaining at a temperature above the threshold for at least a predetermined time period. In some embodiments, the environmental indicator material 106 may include a colorant that migrates with the liquid environmental indicator material 106.

In another embodiment, the environmental indicator material 106 is a gel configured to, in response to a predetermined temperature above a threshold, change viscosity causing the gel to migrate along the substrate 102 for at least a predetermined distance when remaining at a temperature above the threshold for at least a predetermined time period. In some embodiments, the environmental indicator material 106 may include a colorant that migrates with the gel environmental indicator material 106. For example, the material may be a side-chain crystallizable polymer combined with an alkane wax and colored dye as described in of U.S. Patent Publication No. 2022/0178761 applied for by Temptime Corporation, a Zebra Technologies company. Some side-chain crystallizable (SCC) polymers useful in the practice of the present disclosure, alone or in combination, and methods that can be employed for preparing them, are described in O'Leary et al. “Copolymers of poly(n-alkyl acrylates): synthesis, characterization, and monomer reactivity ratios” in Polymer 2004 45 pp 6575-6585 (“O'Leary et al.” herein), and in Greenberg et al. “Side Chain Crystallization of n-Alkyl Polymethacrylates and Polyacrylates” J. Am. Chem. Soc., 1954, 76(24), pp. 6280-6285 (“Greenberg et al.” herein). The disclosure of each of O'Leary et al. and Greenberg et al. is incorporated by reference herein for all purposes. Suitable side-chain crystallizable (SCC) polymers useful in the practice of the present disclosure are also described in U.S. Pat. No. 5,156,911 at column 5, lines 67 to column 7, line 13, which disclosure is incorporated by reference herein for all purposes. Some useful side-chain crystallizable polymers, and monomers for preparing side-chain crystallizable polymers, are also available from commercial suppliers, for example, Scientific Polymer Products, Inc., Ontario, N.Y., Sigma-Aldrich, Saint Louis, Mo., TCI America, Portland Oreg., Monomer-Polymer & Dajac Labs, Inc., Trevose, Pa., San Esters Corp., New York, N.Y., Sartomer USA, LLC, Exton Pa., and Polysciences, Inc. Other materials may be SCC's alone without SCCs, or alkane waxes blended without SCCs.

### Bar Code Layers

FIG. 8 illustrates a bar code layer 115 bearing a bar code symbol 108. The bar code layer 115 may be any material suitable for receiving and displaying the bar code, e.g., porous materials for bar codes printed using inks, etchable materials for laser-etched bar codes, paper, nylon, vinyl, other synthetic polymers such as polytetrafluoroethylene (“PTFE”), or other materials that are suitable for receiving and displaying the bar code. The bar code layer 115 may, for example, be paper or film (e.g., nylon, vinyl, synthetic polymer material, carbon fiber, Teslin synthetic paper, polyethylene (“PE”), polypropylene (“PP”), polytetrafluoroethylene (“PTFE”), polyester, polyethylene, polyolefin, polyimide, vinyl, acrylic film, polypropylene, non-woven nylon, coated and non-coated direct thermal paper, printable polyethylene terephthalate (“PET”), oriented polypropylene (“OPP”), biaxially oriented polypropylene (“BOPP”). The bar code layer 115 may be part of a package or label for perishable host product as described below.

The bar code symbol 108 contains a plurality of cells 120 arranged in a matrix. Each cell 120 is assigned a value. The cells 120 may optionally be square, rectangular, or circular. The arrangement of cells 120 within the matrix encode static values. Static data may be encoded into the contrasting patterns by software, such as a computer application or printer firmware, and may be physically created by processes such as printing laser ablation.

Each cell 120 of the matrix may be used to encode one bit of static data. Each cell in the bar code symbol 108 is colored either nominally colored (e.g., black) or nominally empty or clear (e.g., white). For example, nominally colored cells 120 may be black when printed on a light bar code layer 115 or may be a lighter color when printed on a dark bar code layer 115. The nominally empty or clear cells 120 may not require any printing and may instead allow the base substrate to show through. It will be appreciated that the example approach may be extended to multi-color bar codes. The cell matrix is the visual manifestation of the binary bitmap matrix contained with the area of the symbol bounded by the Finder Pattern 122. The Finder Pattern 122 may be an ‘L’ formed by connected solid lines along two edges of the matrix (shown on the left and bottom edges of the bar code symbol 108 in FIG. 8), also termed a closed limitation line, with a Clock Track formed by an alternating pattern of white and black modules along the opposite edges of the symbol, and also termed an open border line (shown as the top and right edges of the bar code symbol 108 in FIG. 8). It will be appreciated that in other embodiments, other finder patterns may be employed. The bar code symbol 108 may also include quiet spaces, regions surrounding a set of elements (e.g. finder patterns, clock tracks, cells), which is free of contrasting marks, to enable a scanning device to detect the bar code symbol 108 in a captured image. For example, in a Data Matrix bar code there must be an empty area at least one cell width wide surrounding the bar code symbol 108.

The manner in which static data is encoded in the bar code symbol 108, the arrangement of cells 104 within the bar code symbol 108, and any requirements for cells 120 and quiet space are defined by a set of rules, known as a bar code symbology. The bar code symbology may be, for example, Aztec Code, Code 1, CrontoSign, CyberCode, DataGlyphs, Datastrip code, Data Matrix, EZcode, High Capacity Color Barcode, InterCode, MaxiCode, MMCC, NexCode, PDF417, QR Code, ShotCode, SPARQCode, Dot Code symbologies, and the like. Even though several of the illustrative examples described herein refer to Data Matrix, the described techniques and features may also similarly apply to other bar code symbologies.

It should be appreciated that a 2D bar code of a 24×24 Data Matrix is provided in the figures are for illustration purposes only. A 24×24 Data Matrix contains 72 codewords, each formed of eight modules corresponding to the eight bits of the codeword, referred to as a “utah.” The 24×24 bitmap matrix shows the layout of all the 72 codewords in a 24×24 Data Matrix. A “utah” is an arrangement of eight modules to encode one codeword. It may be arranged either as a single connected group with a pattern frequently in the shape of the State of Utah in Data Matrix, or formed as two subgroups of connected modules split across two or more utah patterns. The systems and methods described herein may apply to other Data Matrix sizes and other styles of 2D bar codes. For example, the Data Matrix may be 10×10, 12×12, 14×14, 40×40, up to 144×144 and may have 8, 12, 18, 162 or 2178 codewords respectively.

In some embodiments, the viewing area 117 exposes the environmental exposure indicator material 106 within the bar code symbol 108 covering what would be at least one cell 120 in the matrix absent the viewing area 117, so that, in response to both an activation event and exposure to a predetermined environmental stimulus, the environmental exposure indicator material 106 may change the apparent value of the underlying cell(s) 120 in the bar code matrix. For example, when the viewing area 117 shows the environmental indicator material 106 is in an opaque dark state, it may change the apparent value of an underlying white or empty cell. When the viewing area 117 shows the environmental exposure indicator material 106 is in an opaque or dark color state, the transition into an opaque or dark color state changes the value of the at least one cell 120 in the ‘matrix when the bar code symbol 108 is interpreted using the bar code symbology. The environmental indicator material 106 may transition from light to dark, dark to light, transparent to opaque, opaque to transparent, or any other combination thereof. It will be appreciated that the above-mentioned color state changes are purely exemplary and other color changes or configurations may exist. As one such example, rather than changing color states, the environmental indicator material 106 may travel along a transport structure in response to an activation event as described in further detail below.

Many 2D bar code technologies provide robust error correction capabilities. This allows for a portion of the bar code symbol 108 to be obscured or misread and still the encoded data entirely readable by a scanning device. It should be appreciated that because of error correction capabilities, the overlay can advantageously be used within a 2D bar code without affecting the readability of the bar code symbol 108. Through the use of error correction, such as ISO 16022 Reed-Solomon Error Correction process, which corrects any erroneously identified cells, the underlying matrix is recovered. Thus, static data from the underlying matrix in accordance with the bar code symbology is advantageously processed in the standard manner without being corrupted by the continuously changing color of the environmental indicator material as described below. Therefore, static data, such as a SKU, can be read from the bar code symbol while dynamic data, such as remaining product life, embedded within the bar code continuously changes due to environmental exposure.

Many types of error correcting codes may be used to encode digital information related to the perishable host product. Typically encoded is a dynamic indicator bit pattern of binary-encoded sensor data. Useful error correcting codes include Hamming Codes, Bose-Chaudhuri-Hocquenghem Codes, Golay Codes, Simplex Codes, Reed-Muller Codes, Fire Codes, Convolutional Codes, and Reed-Solomon Codes.

It should be appreciated that by using error correction, the environmental indicator material 106 atop or embedded along a transport structure and/or substrate 102 can advantageously be used within a 2D bar code, without affecting the readability of the overlying (or optionally underlying) 2D bar code symbol 108 by a scanning device. Through the use of error correction, such as ISO 16022 Reed-Solomon Error Correction process, which corrects any erroneously identified modules, the underlying data matrix is recovered. Thus, data from the underlying data matrix is advantageously processed in the standard manner without being corrupted by the continuously changing color of an activated environmental indicator material 106. Therefore, static product data can be read from the 2D bar code symbol 108 while dynamic product data, such as remaining product life, embedded within the bar code symbol 108 continuously changes due to environmental exposure.

For a complete and normative description of the method of error correction employed in Data Matrix, see the current version of International Standard ISO/IEC 16022, “Information technology-Automatic identification and data capture techniques-Data Matrix bar code symbology specification.” Further error correction capabilities and use methods are provided in U.S. Pat. No. 11,455,486 to Temptime Corporation, a Zebra Technologies company.

The environmental exposure indicator material 106 within the viewing area 117 may also be shaped such that the bar code symbol 102 requires minimal error correction to be read, which allows smaller bar code symbols 102 to be used than in previous implementations. For example, overprinting or underprinting with environmental exposure indicator materials 106 in a five-module by five-module patch may require error correction from five “utahs” where each utah contains eight modules, each of which forms one bit of either a data or error correction codeword. In contrast, bar codes with similar accuracy may be printed with environmental exposure indicator materials 106 entirely filling the empty area, which require error correction from two “utahs”. Applying active ink to smaller environmental exposure indicator materials 106 advantageously reduces consumption or waste of active ink for dynamic 2D bar codes while ensuring the bar code symbol 108 provide sufficient cells and accuracy for the environmental exposure indicator material 106 while also leaving additional unused error correction codewords for use elsewhere in recovering the bar code data. It should be appreciated that other patterns and/or designs may be optimized to reduce waste, increase color accuracy, and reduce error correction needed for the 2D bar code.

The bar code symbol 108 and the environmental exposure indicator material 106 viewed through the viewing area 117 or a combination of the bar code symbol 108 and the environmental exposure indicator material 106 viewed through the viewing area 117 may be optically readable by a bar code reader scanning device and readable by a human. In another example, one of the bar code symbols 108 and the environmental exposure indicator materials 106 viewed through the viewing area 117 may be readable by a scanning device and unreadable to a human. Additionally, both the bar code symbol 108 and environmental exposure indicator material 106 viewed through the viewing area may not be human readable (e.g., the environmental exposure indicator material 106 is in the ultraviolet (“UV”) spectrum by containing an ultraviolet active pigment and is unreadable by a human). Specifically, the bar code symbol 108 may be entirely human visible, only the environmental exposure indicator material 106 may be human visible, or none of the bar code symbol 108 may be human visible. Additionally, the readability and human visibility of the bar code symbol 108 and environmental exposure indicator material 106 viewed through the viewing area 117 may only be detectable in one of the environmental exposure indicator material's 106 color states.

To further improve the accuracy of cumulative indicators, and to give a point of calibration, both digital and visual, a color reference area can be added to either the substrate 102 or the clear overlaminate film 110. In some embodiments, the color reference area is added in an exterior area of bar code symbol 108. Advantageously, scanning devices may be calibrated by the color reference areas to determine if the perishable host product no longer has remaining life. The scanning device may use a color reference within the color reference area and compare that color reference to the color state of the environmental indicator material 106 viewed through the viewing area 117. In this example, when the sensor area reaches the same color shade as the color reference area, the perishable host product the bar code symbol 108 is printed on would be deemed to be at endpoint.

The one or more color reference areas of a known optical property, such as a known reflectivity, can be used in auto-calibration of the scanning device at the reading color of interest. The color reference areas may be positioned adjacent to the bar code symbol 108. The color reference areas may be printed as part of the substrate 102 or the clear overlaminate film 110 and may appear adjacent to specific cell positions within the sensor-augmented bar code symbol 108. The color reference area color corresponds to the change of the viewing area 117 from one color state to another color state.

The color reference areas may be used in assessing the environmental indicator material 106. For example, a scanning device may be calibrated based on an optical property of the color reference area. In another example, an optical property of the environmental indicator material 106 as viewed through the viewing area 117 may be compared to a related optical property of the color reference area. The optical properties of the environmental indicator material 106 and the color reference area may include an instantaneous value or an average value of one or more of the following properties: color, reflectance, intensity, color density, or RGB values. For example, the color state of the environmental indicator materials 106 and the color of the color reference area may be compared when assessing and/or analyzing the viewing area 117 for the environmental indicator material 106.

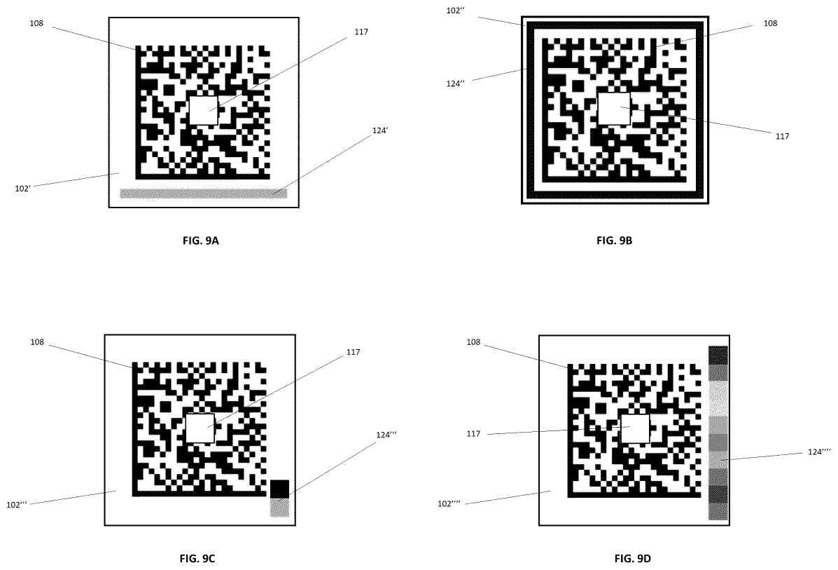

As illustrated by FIGS. 9A-9D, the color reference areas 124′, 124″, 124′″, 124″″ may be positioned in different spaces surrounding the bar code symbol 108. FIG. 9A shows a color reference area 124′ displaying one color state adjacent to the bar code symbol 108. The color reference area 124′ is affixed to the substrate 102′. The illustrated embodiment includes a rectangular color reference area 124′, but the color reference area may instead by a square, circle, or any other shape in any size. FIG. 9B illustrates a color reference area 124″ that completely surrounds the bar code symbol 108. The color reference area 124″ is affixed to the substrate 102″. FIG. 9C demonstrates a color reference area 124′″ that includes two color samples. The color samples correspond to two different color states of viewable from the viewing area 117 which includes the presence or absence of the environmental indicator material 106. The color reference area 124′″ is affixed to the substrate 102′″. Finally, FIG. 9D illustrates a color reference area 124″″ containing multiple colors to allow for a more precise read of the environmental exposure indicator material's 106 color state. The color reference area 124″″ is affixed to the substrate 102″″. FIGS. 9A-9D represent color reference areas shown for illustrative purposes only. It should be appreciated that the color reference areas may comprise any shape or orientation within or outside of the bar code symbol 108. In yet other embodiments, the bar code symbol 108 may be used as the color reference area 124.

### Example Time—Temperature Exposure Indicator

The activatable indicator of the present disclosure may be combined with some features of the time-temperature indicator of U.S. Patent Publication No. 2022/0178761 applied for by Temptime Corporation, a Zebra Technologies company.

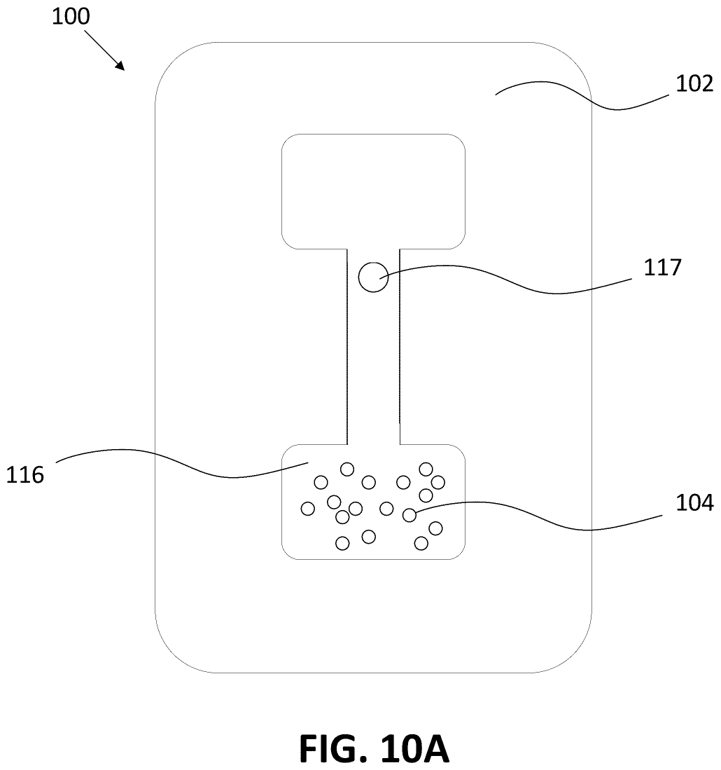

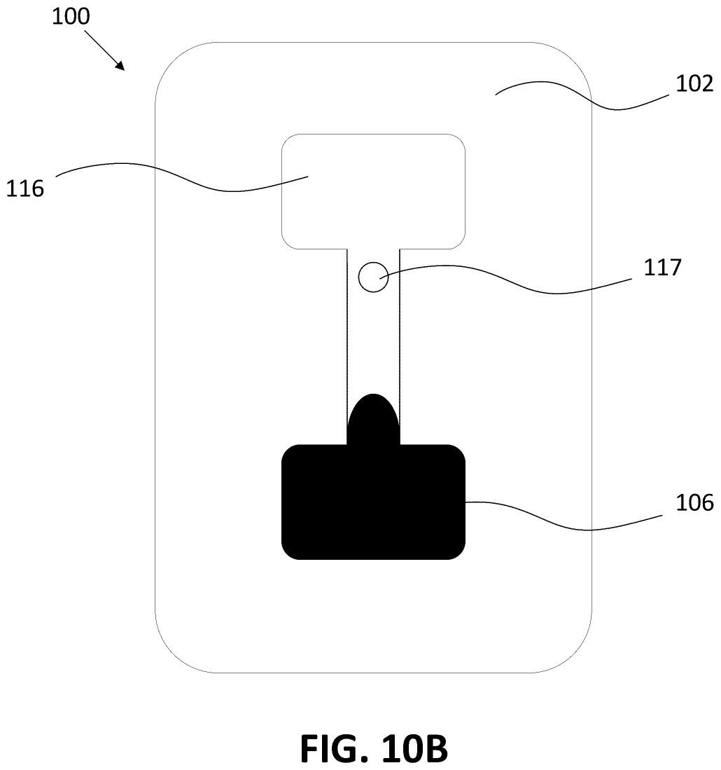

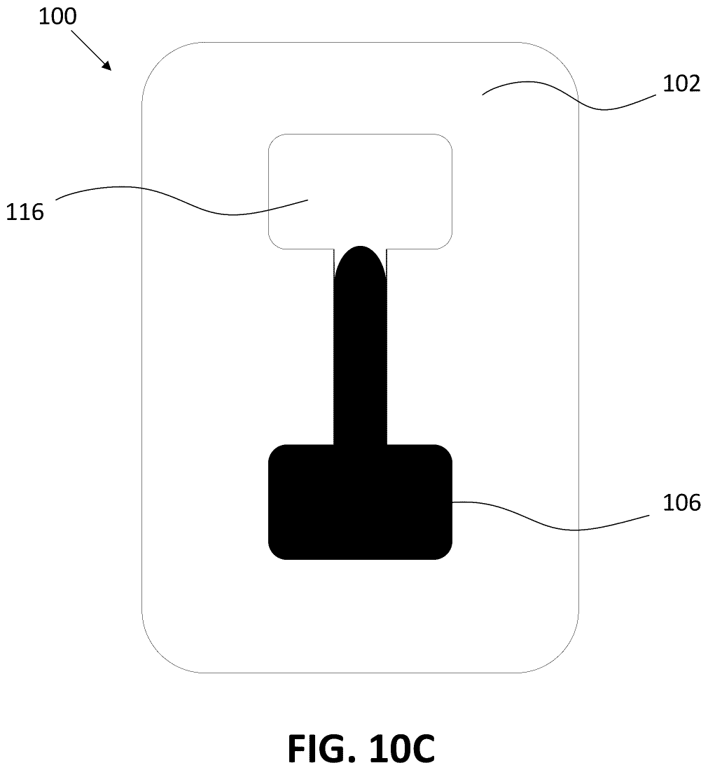

In some embodiments such as those shown in FIGS. 10-13, the environmental indicator material 106 may be configured to migrate along a wick 116. The wick 116 may be on or in the substrate 102 and positioned near the microcapsules 104 such that upon activation the environmental indicator material 106 may migrate along the wick 116. In one example, the microcapsules may be deposited on the wick at one end of the wick 116 or the microcapsules 104 can be deposited on the substrate 102 and the wick 116 can be deposited on the microcapsules 104 and the substrate 102 such that one end of the wick 116 overlays the microcapsules 104. Thus, the wick 116 can be used as a tool of measurement to determine the extent or duration of the exposure the environmental indicator material 106 has had to the predetermined environmental stimulus. With a suitable material the migration of the environmental indicator material 106 along the wick may indicate the historical exposure to the predetermined environmental stimulus for a particular time period; the longer the exposure the more the material may travel down the wick.

The wick may be any material capable of allowing the environmental indicator material to migrate upon, including filter paper; pulverized filter paper; fine silica gel; porous films containing polytetrafluoroethylene resin or silica gel; TESLIN microporous synthetic sheet; non-woven, spun bonded materials including non-woven, spun-bonded high-density-polyethylene, polypropylene and polyester, or non-woven, spun bonded blends of any two or more such polymers. It will be appreciated that the use of a wick is purely exemplary and transport structures may be known to an artisan practicing ordinary skill in the art.

In one example illustrated in FIGS. 10A-10C, the activatable environmental exposure indicator 100 may include a substrate 102, the wick 116 supported by the substrate 102 and the microcapsules 104 containing the environmental indicator material 106 supported by the substrate 102 (the bar code layer 115 has been removed for clarity). When the activatable indicator 100 is initially provided, the environmental indicator material 106 comprises a solid indicator material, e.g., a mixture of a synthetic polymeric material and a wax material. The microcapsules 104 are configured to respond to an activation temperature, an activation pressure, or a combination of an activation temperature and activation pressure by fracturing, melting, breaking, dissolving, or becoming porous. This response releases the environmental indicator material 106 from the microcapsules 104. In FIG. 10A, the unactivated microcapsules 104 containing the environmental indicator material 106 lay atop the wick 116 (e.g., one end of the wick 116). After the microcapsules 104 are activated, the released environmental indicator material 106 may begin to migrate along the wick 116 as shown in FIG. 10B. Alternatively, the released environmental indicator material 106 may be formulated to remain where the microcapsules are disposed (e.g., at an end of the wick 116) until or unless the released environmental indicator material 106 is exposed to the predetermined environmental stimulus at which time the released environmental indicator material 106 can migrate along the wick 116, e.g., while they remain at a temperature below the melting of the environmental indicator material 106, or a temperature above which the environmental indicator material 106 wicks freely with a reduced viscosity. After a given period of time, the environmental indicator material 106 may sufficiently migrate along the wick 116 such that the wick 116 is mostly covered in the environmental indicator material 106 as shown in FIG. 10C. In embodiments with a bar code layer 115, the distance the environmental indicator material 106 migrates along the wick may correspond to a viewing area 117.

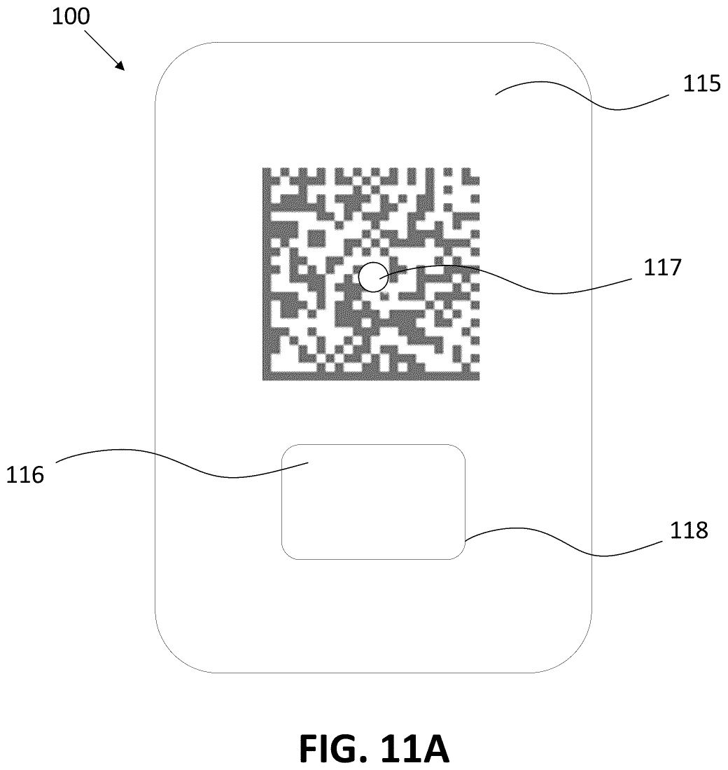

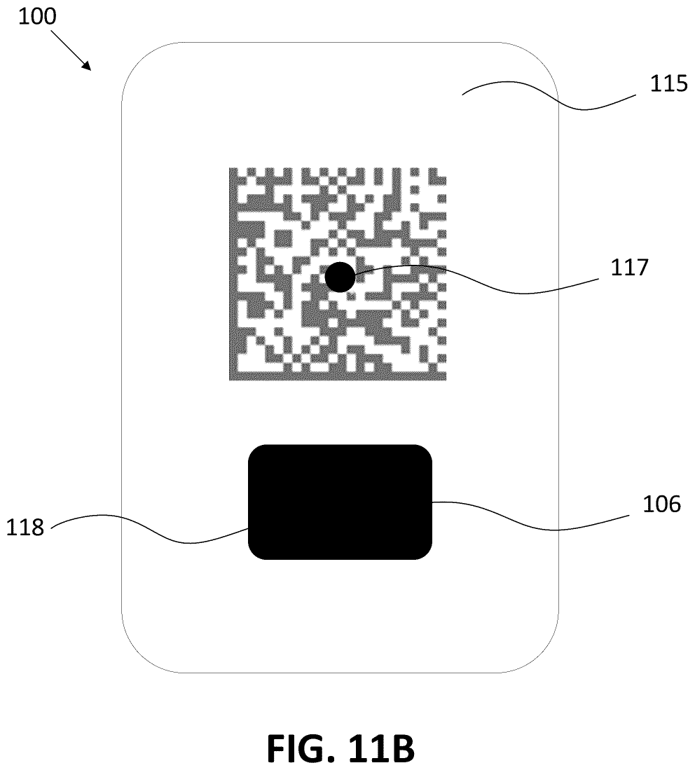

FIG. 11A shows an unactivated activatable environmental exposure indicator 100 which can be seen by a lack of environmental indicator material 106 in the viewing area 117 contained on the bar code layer 115, whereas FIG. 11B shows an activated activatable environmental exposure indicator 100 having been exposed to a predetermined environmental stimulus, e.g., to a temperature above the melting point of the environmental indicator material 106.

In some embodiments, the example unactivated activate environmental exposure indicator 100 as illustrated in FIG. 11A-11B can include a second viewing area 118. The second viewing area 118 allows a user to detect a transport structure such as a wick 116 contained below the bar code layer 115. The second viewing area 118 overlays both the wick 116 and at least a portion of the environmental indicator material 106 prior to activation. The second viewing area 118 is particularly useful in embodiments where the environmental indicator material 106 is deposited beneath the wick 116 prior to activation. Upon activation, the environmental indicator material 106 can be absorbed by the wick 116 such that the environmental indicator material 106 bleeds through the wick 116 and is visible through the second viewing area 118. By the use of a wick 116, a user may optically determine whether an activation event has occurred and whether the environmental indicator material 106 has been exposed to a predetermined environmental stimulus.

The environmental indicator material 106 provides an indication of the exposure of the activatable environmental exposure indicator 100 to a predetermined environmental stimulus and/or provides an indication of duration of time elapsed since an activation event. In their initial non-activated configuration such as that shown in FIG. 5, the microcapsules 104 may prevent the environmental indicator material 106 from operating to provide the indication of exposure to the predetermined environmental stimulus, e.g. by preventing an environmental indicator material state change (e.g., by separating two materials that would otherwise interact, by keeping the environmental indicator material 106 from being exposed to the relevant predetermined environmental stimulus, or by preventing movement, flow, or wicking of the environmental indicator material after it changes to a mobile state, such as a liquid, or by hiding the environmental indicator material (if the microcapsules were opaque and the environmental indicator material color changes in response to environmental exposure).

Upon activation, the microcapsules 104 are ruptured, and the environmental indicator material 106 is exposed to the environment and thus is able to respond to the predetermined environmental stimulus when it occurs. As one such example, FIG. 5 illustrates an environmental indicator material 106 contained within microcapsules 104 prior to an activation event. FIG. 6 illustrates the environmental indicator material 106 having been released from the microcapsules 104 following an activation event. In this example, the microcapsules 104 have been ruptured from exposure to an activation pressure or an activation temperature.

The environmental indicator material 106 is configured to melt at a predetermined threshold temperature, and then move along the wick 116 when melted. The melted material is chosen so that it takes a predetermined amount of time to move along the wick 116 at or about the predetermined threshold temperature, and so that the environmental indicator material changes state at the predetermined amount of time.

The predetermined threshold temperature may be chosen at any suitable range depending on the applications. For example ranges may be chosen to show whether a product has been removed from a freezer, or a refrigerator, or exposed to another higher temperature. Example predetermined threshold temperatures may be from about −10° C. to 80° C., from about 0° C. to 70° C., from about 0° C. to 60° C., from about 1° C. to 30° C., from about 2° C. to 20° C., from about 5° C. to 15° C., from about 5° C. to 65° C., from about 6° C. to 15° C., from about 8° C. to 12° C., from about 9° C. to 11° C., from about 0° C. to 150° C., from about 0° C. to 50° C., from about 50° C. to 100° C., from about 90° C. to 110° C., from about 100° C. to 150° C., from about 100° C. to 200° C. It will be appreciated that the activation temperature ranges given are purely exemplary and other ranges may be known to an artisan practicing ordinary skill in the art. A predetermined threshold temperature around 10° C. may be used to show removal from refrigeration. The wick 116 and the environmental indicator material 106 are configured so that exposure to at least the predetermined threshold temperature for at least a predetermined exposure time results in at least a predetermined amount of movement of the environmental indicator material 106 along the wick 116.

In some cases, pressure may also contribute to the activation, e.g., by breaking microcapsules 104, either alone like an impact printer, or in combination with elevated temperature. In some examples, the activation pressure required to activate the microcapsules 104 may be from about 1.5 to 8 pounds per square inch or from about 4 to 15 pounds per square inch. It will be appreciated that the activation pressure ranges given are purely exemplary and other ranges may be known to an artisan practicing ordinary skill in the art.

The environmental indicator material 106 may include a synthetic polymeric material, e.g., a polymer having side chain crystallinity (SCC). Two or more SCC polymers may be blended in order to tune the properties of the material. In an example embodiment, the polymer having side chain crystallinity (SCC) is a polymer or a copolymer having at least one crystallizable side chain, for example a C4-30 aliphatic group; a C6-30 aromatic group; a linear aliphatic group having at least 10 carbon atoms; a combination of at least one aliphatic group and at least one aromatic group, the combination having from 7 carbon atoms to about 30 carbon atoms; a C10-C22 acrylate; a C10-C22 methacrylate; an acrylamide; a methacrylamide; a vinyl ether; a vinyl ester; a fluorinated aliphatic group having at least 6 carbon atoms; or a p-alkyl styrene group wherein the alkyl group has from about 8 carbon atoms to about 24 carbon atoms. Examples of such synthetic polymeric material are described in detail in U.S. Pat. Nos. 9,546,911 and 8,671,871, by Temptime Corporation, a Zebra Technologies company, which are fully incorporated herein by reference for all purposes.

The synthetic SCC polymer may be selected so that it is solid at or below the stop temperature and is, or can become, a viscous liquid when at or above the predetermined threshold temperature. Such synthetic SCC polymer is meltable, and can also be hydrophobic, if desired. The synthetic SCC polymer may have a molecular weight of at least about 1,000 Da. In an example embodiment, the synthetic SCC polymer can have desirably sharp transitions from a solid state to a liquid state. When the environmental indicator material returns to a temperature at or below the stop temperature, the material may re-solidify, and thus stop moving.

The wax material may be at least one of an alkane wax, an alkyl ester, a natural wax, or a modified natural wax. In an example embodiment, the wax material comprises at least one of an undecane, a dodecane, a tridecane, a tetradecane, a pentadecane, a hexadecane, a heptadecane, an octadecane, a nonadecane, an eicosane, a heneicosane, a hexanoic acid, ethyl lactate, a paraffin wax, a microcrystalline wax, carnauba wax, beeswax, Chinese wax, shellac wax, spermaceti, tallow, palm wax, soy wax, 15 lanolin, wool grease, a waxy polymer, a waxy copolymer, a polyolefin, polyethylene, polypropylene, an ethylene-vinyl acetate copolymer, an ethylene-acrylic acid copolymer, and combinations thereof. In some disclosed examples the wax material is a blend of two alkane waxes. For example, the wax material may be a blend of hexadecane and pentadecane in a weight ratio of hexadecane to pentadecane from about 40:60 to about 1:95, from about 30:70 to about 10:90, from about 20:80 to about 10:90, or more preferably about 15:85. Other ranges may be chosen to tune the properties of the material. It will be appreciated that other combinations and proportions may also be employed. While other materials with the similar melting and flow properties as these wax materials might be employed, waxes like those disclosed herein generally tend to be stable, safe, have low volatility, and are easy to use in the manufacturing process.

In an example embodiment, a ratio of the synthetic polymeric material to the wax material is in a range from about 10:90 to about 90:10, from about 20:80 to about 80:20, from about 30:70 to about 70:30, from about 40:60 to about 60:40, from about 50:50 to about 60:40 and preferably from about 52:48 to about 58:42, e.g., about 55:45.

In an example embodiment, the predetermined exposure time for the environmental indicator material 106 to reach the predetermined amount of movement along the transport element (e.g., the wick 116) at the predetermined threshold temperature is in a range of about 0.1-48 hours or even up to 72 hours or longer, about 1-24 hours, about 2-15 hours, about 2-10 hours, about 3-9 hours, or about 4-8 hours.

In an example embodiment, the predetermined threshold temperature is about 10° C., which corresponds to removal from a typical refrigerator unit, and the predetermined exposure time for the environmental indicator material 106 to reach the predetermined amount of movement along the transport element at the predetermined threshold temperature is in a range of about 4-8 hours. Other thresholds may be chosen, depending on the properties of the materials or host products being monitored and particular applications.

### Example Humidity Indicator

In another example, the microcapsules 104 may be used in an activatable indicator for other environmental stimuli. A humidity sensitive material, e.g., a hygroscopic or hydrophilic material, can be encapsulated in a moisture resistant microcapsule. Example indicator materials for the indicator may include hydrochromic inks, polar protic solvents, polar pigments, and/or polar polymers. Example materials for the shell may include a gel, gelatin, protein, polyurea formaldehyde, polymelamine formaldehyde, wax material, melamine, or an emulsion. The shell materials may also be hydrophilic.

The microcapsules 104 itself responds when it reaches a temperature of in a range from about −20° C. to 0° C., from about −10° C. to 80° C., from about 0° C. to 70° C., from about 0° C. to 60° C., from about 0° C. to 100° C., from about 1° C. to 30° C., from about 2° C. to 20° C., from about 5° C. to 15° C., from about 5° C. to 65° C., from about 6° C. to 15° C., from about 8° C. to 12° C., from about 9° C. to 11° C., from about 0° C. to 150° C., from about 0° C. to 50° C., from about 50° C. to 100° C., from about 90° C. to 110° C., from about 100° C. to 150° C., from about 100° C. to 200° C., or from about 100° C. to 300° C. It will be appreciated that the activation temperature ranges given are purely exemplary and other ranges may be known to an artisan practicing ordinary skill in the art. In some cases, pressure may also contribute to the activation, e.g., by breaking microcapsules 104, either alone like an impact printer, or in combination with elevated temperature. In some examples, the activation pressure required to activate the microcapsules 104 may be from about 1.5 to 8 pounds per square inch or from about 4 to 15 pounds per square inch. It will be appreciated that the activation pressure ranges given are purely exemplary and other ranges may be known to an artisan practicing ordinary skill in the art.

### Example Cumulative Heat Exposure Indicator

In another example, the microcapsules 104 may be used in an activatable cumulative heat exposure indicator. For example, modifications may be made to the cumulative heat exposure indicator of U.S. Pat. No. 9,011,794 of Freshpoint Quality Assurance Ltd. This indicator relies on etching of a metal substrate by phosphoric acid or other etchant material. The rate of etching is sensitive to temperature and provides an indication of cumulative temperature exposure. For example, etching of the metal layer with the etchant can cause a change, e.g., in an optical property (absorption, transmission, reflectivity, color, hue, etc.) of the cumulative heat exposure indicator and/or in an electrical property (conductivity/resistance, capacitance, etc.) of the cumulative heat exposure indicator. However, by encapsulating the phosphoric acid or other etchant in microcapsules (e.g., as the environmental indicator material 106 in the microcapsules 104), the microcapsules can be disposed on the metal substrate and etchant encapsulated in the microcapsules will not etch the metal substrate until the microcapsules are placed in the activated configuration to release etchant and after the released etchant onto the metal substrate and the released etchant is subsequently exposed a predetermined environmental stimulus (e.g., temperatures above a response temperature of the environmental indicator material). Using this approach, the cumulative heat exposure indicator including the microcapsules disposed on the metal substrate can be stored at temperatures above the response temperature without causing a detectable response while in the non-activated configuration, and after the microcapsules are ruptured, releasing the etchant, in response to an activation event, the indicator can operate normally (e.g., be responsive to temperature to produce a detectable response in response to etching of the metal substrate). The microcapsules 104 may be any material that inhibits wicking prior to activation that does not have an affinity for the dye or wax. In this manner an improved cumulative heat exposure indicator may be provided.

### Example Activatable Time—Temperature Indicator

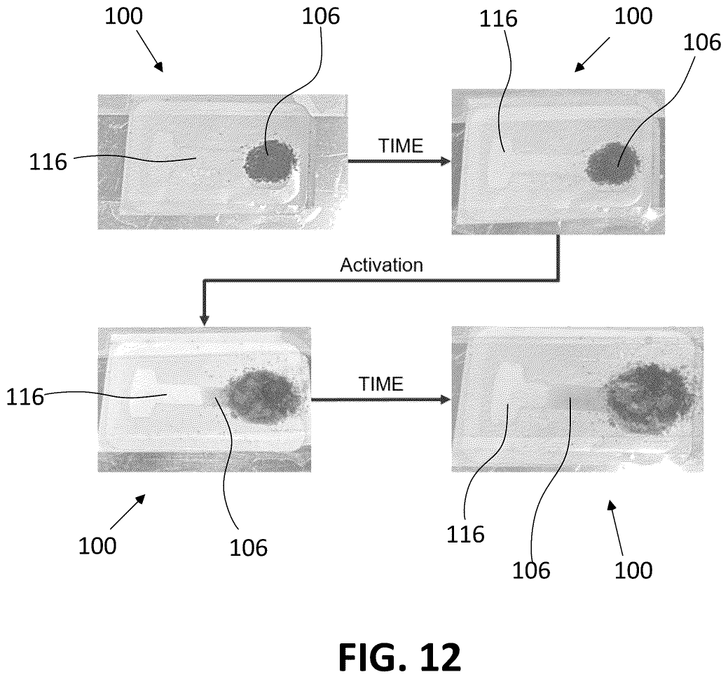

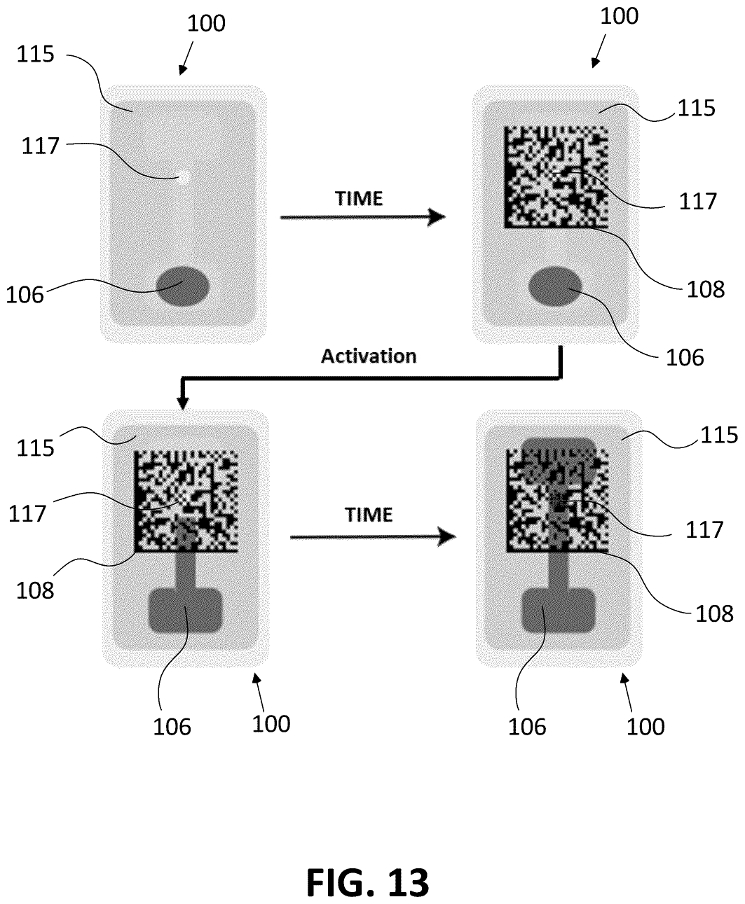

FIGS. 11A-11B and 13 show an example activatable indicator that combines a time-temperature indicator with a bar code symbol. The time-temperature indicator may operate using modified features of a Zebra/Temptime Limitmarker D-A time-temperature exposure indicator, although it will appreciate that other forms of time-temperature indicator may be employed. The environmental indicator material used is a solvent based SCC with an Alkane Wax blend combined with a colored dye, similar to U.S. Patent Publication No. 2022/0178761 applied for by Temptime Corporation, a Zebra Technologies company. However, unlike the Limitmarker D-A, the SCC-Wax blend may be incorporated in microspheres are described previously. Thus the environmental indicator will not be activated, and the environmental material 106 will not flow until the microspheres are ruptures. Once the environmental indicator is activated, the Wax-SCC blend is free to flow when it becomes a liquid. FIGS. 10A-10C show the internals of the indicator prior to the addition of the bar code layer 115. FIGS. 11A-11B show the same indicator with the bar code layer 115 and the viewing area 117. In FIG. 11A, the white dot of the viewing area 117 indicates a temperature excursion has not occurred. In FIG. 11B, the black dot of the viewing area 117 indicates a temperature excursion has occurred. FIGS. 10A-10C show the internals of the same indicator after exposure to excess temperature for two different periods of time. FIG. 10B shows the internals of the same indicator soon after exposure to excess temperature, whereas FIG. 10C shows the internals of the same indicator after a longer period of time since the exposure to excess temperature than FIG. 10B. The environmental indicator material 106 melts and transits the wick 116 carrying the colored dye with it. With the bar code layer 115 on in FIG. 11B, the viewing area 117 appears in a color different from than the initial color shown in FIG. 11A, such as red, showing to a user that the environmental indicator has been exposed to excess temperature for more than the minimum time. It will be appreciated that the colors white and red are purely exemplary and other color combinations may be used in the environmental indicator material to signify exposure. FIGS. 12-13 show the example indicator in several phases before activation and phases when exposed over time to a temperature above the melting point of the environmental indicator material for an extended time. FIG. 12 illustrates the indicator without a bar code layer 115 and FIG. 13 illustrates the indicator with a bar code layer 115. The bar code layer 115 is shown as being transparent in FIG. 13 for illustrative purposes. In accordance with embodiments of the present disclosure, the bar code layer 115 can be opaque or can be transparent but coated with an opaque material, e.g., except with respect to the viewing areas which may be cutout of the bar code layer 115 or transparent windows (e.g., devoid of the opaque coating). This structure is the internal structure similar to the Limitmarker D-A indicator mentioned above, without the covering material. As can be seen from the photo, the environmental indicator material 106 is contained in the reservoir and does not migrate prior to an activation event. After activation by exposure to heat and pressure sufficient to rupture the microcapsules 104, the environmental indicator material 106 begins to migrate along the wick 116. When the environmental indicator material 106 melts and migrates along the wick 116, it produces an observable indication of a temperature exposure in the Limitmarker indicator design. After yet more time, the environmental indicator material 106 will continue to further migrate along the wick 116. Finally, the environmental indicator material 106 will reach a sufficient distance along the wick 116 that the observable indication of temperature exposure can be seen even with a viewing area 117 in the bar code layer 115 adhered to the indicator.

### Activation Methods

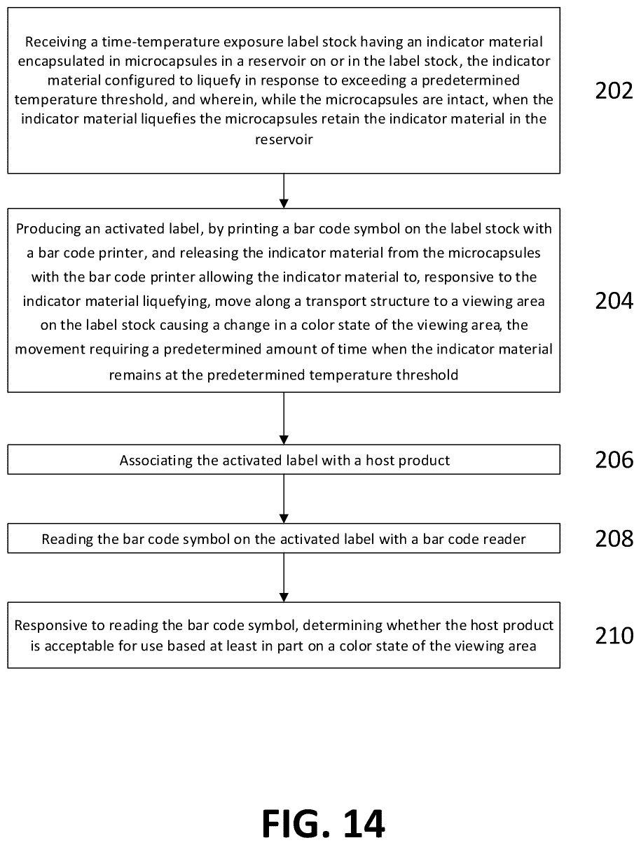

An example procedure 200 for monitoring exposure to time-temperature is disclosed herein and shown in FIG. 14. In 202, a time-temperature exposure label stock (e.g., the substrate 102) having an indicator material (e.g., the environmental indicator material 106) encapsulated in microcapsules (e.g., the microcapsules 104) in a reservoir (e.g., the wick 116) on or in the label stock is received. For example, this may be any of the examples described previously in the present disclosure, e.g., the examples shown in FIGS. 10A-13. In 204, an activated label is produced by printing a bar code symbol (e.g., the bar code symbol 108) with a bar code printer, and by releasing the indicator material from the microcapsules with the bar code printer allowing the indicator material to, responsive to the indicator material liquefying, move along a transport structure to a viewing area (e.g., the viewing area 117) on the label stock causing a change in a color state of the viewing area. To print the bar code symbol, the bar code printer is loaded with a substrate such as a label stock or one of a Polyolefin, polyamide, polypropylene, polyester polyimide, Polyart synthetic paper, nylon, or PPG Teslin paper. The substrate loaded into the bar code printer may be in a roll to print multiple bar code symbols at once. The label stock may be a modified thermal paper and the bar code printer may be a direct thermal printer capable of activating the environmental indicator material by releasing the environmental indicator material from the microcapsules through applying an activation temperature or activation pressure. In will be appreciated that other printing approaches, for example laser etching, may also be used, with the laser or some other source of heat and/or pressure used to activate the indicator. In some embodiments, the substrate requires cold storage prior to printing the bar code symbol, but it will be appreciated that by using the activatable indicator this may be avoided in most situations.

In 206, the activated label is associated with a host product. This may be done by registering the bar code symbol through a scanning device. During registration, a scanning device is used to read the bar code symbol which simultaneously assigns the bar code symbol with relevant custom data. This data thus becomes digitized. In 208, the bar code symbol on the activated label is read with a bar code reader. In 210, responsive to reading the bar code symbol, the host product is determined to be acceptable for use based at least in part on a color state of the viewing area.

The host product may be determined to be acceptable for use in a variety of manners. As one example, the degree to which the viewing area contains the environmental indicator material may influence the value of the bar code symbol. For instance, in one such embodiment, the value of the bar code symbol changes based on a change in the viewing area (e.g., the environmental indicator material spreading to at least a portion of wick viewable through the viewing area). The value of the bar code symbol may change in multiple instances as the environmental indicator material travels along a path viewable through the viewing area, the value changing at different locations along the path. Alternatively, the change of the color state of the viewing area may not change a value of the bar code symbol in a symbology of the bar code symbol. In other embodiments, the bar code symbol encodes data that can be used to determine prior exposure to time-temperature by interpreting the color state of the viewing area. In this example, the bar code symbol would not be layered atop the environmental indicator material, but instead be adjacent to the environmental indicator material. In yet another embodiment, the host product may be determined to be acceptable for use by scanning the bar code symbol and received product information which can be cross-referenced against the viewing area displaying the environmental indicator material. The symbology of bar code symbol 108 with the viewing area 117, and the location of the active color-changing regions with respect to the underlying static bar code symbol can be configured and interpreted using methods described in U.S. Pat. No. 10,318,781 to Temptime Corporation, a Zebra Technologies company.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method of monitoring exposure to time-temperature, comprising:
receiving a time-temperature exposure label stock having an indicator material encapsulated in microcapsules in a reservoir on or in the label stock, the indicator material configured to liquefy in response to exceeding a predetermined temperature threshold, and wherein, while the microcapsules are intact, when the indicator material liquefies the microcapsules retain the indicator material in the reservoir;
producing an activated label, by
printing a bar code symbol on the label stock with a bar code printer, and
releasing the indicator material from the microcapsules with the bar code printer allowing the indicator material to, responsive to the indicator material liquefying, move along a transport structure to a viewing area on the label stock causing a change in a color state of the viewing area, the movement requiring a predetermined amount of time when the indicator material remains at the predetermined temperature threshold;
associating the activated label with a host product;
reading the bar code symbol on the activated label with a bar code reader; and
responsive to reading the bar code symbol, determining whether the host product is acceptable for use based at least in part on a color state of the viewing area.

2. The method of claim 1, further comprising:
interpreting the color state of the viewing area based, at least in part on information read from the bar code symbol.

3. The method of claim 1, wherein the viewing area is located in the bar code symbol, and information read from the bar code symbol by the bar code reader varies based on the color state of the viewing area.

4. The method of claim 3, wherein a presence of the indicator material in the transport structure or the reservoir does not affect the information read from the bar code symbol.

5. The method of claim 1, wherein the indicator material includes a meltable solid mixed with a colorant, and wherein the colorant is transported to the viewing area when the material moves along the transport structure to the viewing area, the colorant changing the color state of the viewing area when it reaches the viewing area.

6. The method of claim 1, wherein the transport structure is a microchannel or a wick in fluid communication with the reservoir and viewing area.

7. (canceled)

8. The method of claim 1, wherein the temperature threshold is in the range of 5 C-65 C, 6 C-15 C, 8 C-12 C, or 9 C-11 C.

9. The method of claim 1, wherein the predetermined amount of time is in the range of 45 minutes to 6 months, 2 to 4 hours, or 4 to 8 hours.

10. The method of claim 1, wherein the indicator material is released by rupturing the microcapsules with a force applied by the bar code printer.

11. The method of claim 10, wherein heat from the bar code printer weakens the microcapsules before the microcapsules are ruptured.

12-13. (canceled)

14-15. (canceled)

16. The method of claim 15, wherein the activation temperature is in the range of −20 C-0 C, 0 C-100 C, 90 C-110 C, 100 C-200 C, or 100 C-300 C.

17. (canceled)

18. A machine readable time-temperature exposure indicator label, comprising:
a substrate;
a bar code symbol printed on substrate, the bar code symbol being an error-correcting two-dimensional bar code;
a reservoir coupled to the substrate;
a viewing area on the substrate;
a transport structure providing fluid communication between the reservoir and the viewing area;
an indicator material contained in the reservoir, the indicator material configured to liquefy at a predetermined temperature threshold, and once liquefied to travel along the transport structure from the reservoir to the viewing area, the passage of the indicator material from the reservoir to the viewing area requiring a predetermined time when the indicator material is maintained at the predetermined temperature threshold; and
a plurality of ruptured microcapsules mixed with the indicator material in the reservoir.

19-20. (canceled)

21. The label of claim 18, wherein the indicator material further comprises a colorant mixed with a meltable solid, wherein the colorant is transported with the meltable solid as the indicator material travels along the transport structure, and the colorant changes a color state of the viewing area when it is transported to the viewing area.

22. The label of claim 21, wherein the bar code symbol has a symbology, and the viewing area is located within the bar code symbol, and the change in the color state of the viewing area causes a change in data in the symbology of the bar code symbol that is readable with a bar code scanner programmed to read the bar codes symbols with the symbology.

23. The label of claim 22, wherein the transport structure is covered, so that passage of the colorant through the transport passage does not affect the data of the bar code symbol before the colorant reaches the viewing area.

24. The label of claim 21, wherein the change of the color state of the viewing area does not change value of the bar code symbol in symbology of the bar code symbol, and the bar symbol encodes data that can be used to determine prior exposure to time-temperature by interpreting the color state of the viewing area.

25-26. (canceled)

27. The label of claim 18, wherein the indicator material comprises a component selected from the group consisting of a polymer having side-chain crystallinity, an alkane wax, a gel, a protein, a polyurea formaldehyde, a polymelamine formaldehyde, a wax material, and an emulsion.

28. (canceled)

29. The label of claim 18, wherein the temperature threshold is in the range of 5 C-65 C, 6 C-15 C, 8 C-12 C, or 9 C-11 C.

30. The label of claim 18, wherein the predetermined amount of time is in the range of 45 minutes to 6 months, 2 to 4 hours, or 4 to 8 hours.

31. The label of claim 18, wherein the indicator material further comprises a component selected from the group consisting of a polymer having side-chain crystallinity, an alkane wax, a gel, a protein, a polyurea formaldehyde, a polymelamine formaldehyde, a wax material, and an emulsion.

32. The label of claim 31, wherein the indicator material further comprises a side-chain crystalline polymer.

33. (canceled)

34. The label of claim 33, wherein the activation temperature is in the range of −20 C-0 C, 0 C-100 C, 90 C-110 C, 100 C-200 C, or 100 C-300 C.

35. The label of claim 33, wherein the activation temperature is greater than the temperature threshold.

36. An activatable machine readable time-temperature exposure indicator label:
a substrate;
a bar code symbol printed on the substrate, the bar code symbol being an error-correcting two-dimensional bar code;
a reservoir coupled to the substrate;
a viewing area on the substrate;
a transport structure providing fluid communication between the reservoir and the viewing area; and
an indicator material encapsulated by microcapsules contained in the reservoir, the indicator material configured to liquefy in response to exceeding a predetermined temperature threshold, and wherein, while the microcapsules are intact, when the indicator material liquefies the microcapsules retain the indicator material in the reservoir, and when the indicator material is released from the microcapsules and liquefies, the liquefied indicator material travel along the transport structure from the reservoir to the viewing area, the passage of the indicator material from the reservoir to the viewing area requiring a predetermined amount of time when the indicator material is maintained at the predetermined temperature threshold.

37-56. (canceled)

57. An activatable time-temperature indicator label stock to indicate past exposure to an exposure temperature above a predetermined temperature threshold for at least a predetermined exposure time at the exposure temperature, the label stock comprising:
a substrate;
a reservoir on or in the substrate containing an indicator material encapsulated in microcapsules, the indicator material configured to melt at the predetermined temperature threshold, the microcapsules, when intact, containing the indicator material in both its solid and melted state;
a viewing area;
a transport structure on or in the substrate, providing fluid communication between the reservoir and the viewing area;
wherein the indicator material, when liquefied and released from the microcapsules by rupturing of the microcapsules, flows from the reservoir to the viewing area; and
wherein the indicator material, when held at the predetermined threshold temperature, requires at least the predetermined exposure time to flow from the reservoir to the viewing area;
wherein the microcapsules are configured to rupture in response to at least one of a predetermined force and heating above an activation temperature, the activation temperature being greater than the predetermined temperature threshold.

58-63. (canceled)
